(19) United States
(12) Patent Application Publication
(10) Pub. No.: US 2026/0061327 A1
(43) Pub. Date: Mar. 5, 2026

(54) CUSTOMIZABLE MATCHMAKING FOR USERS OF ONLINE VIRTUAL EXPERIENCES

(71) Applicant: Roblox Corporation, San Mateo, CA (US)

(72) Inventors: Max BIZE, San Mateo, CA (US); Yongzhen QIU, San Mateo, CA (US); Colin DILLARD, San Mateo, CA (US); Deepa KANNAN, San Mateo, CA (US); Chen QU, San Mateo, CA (US); Karun CHANNA, Redwood City, CA (US); Owen THOMSON, San Mateo, CA (US); Elle DEPPE, San Mateo, CA (US); Varna DAS, San Mateo, CA (US); Michael ZHOU, San Mateo, CA (US); Roger LUO, San Mateo, CA (US); Mathieu Francois CHAUVIN, San Mateo, CA (US)

(73) Assignee: Roblox Corporation, San Mateo, CA (US)

(21) Appl. No.: 19/319,445

(22) Filed: Sep. 4, 2025

Related U.S. Application Data
(60) Provisional application No. 63/691,286, filed on Sep. 5, 2024.
(60) Provisional application No. 63/779,004, filed on Mar. 27, 2025.

(51) Int. Cl. A63F 13/795; G06F 3/04847

(52) U.S. Cl. CPC A63F 13/795; G06F 3/04847

(57) ABSTRACT

Implementations relate to methods, systems, and computer-readable media to perform customized matchmaking. In some implementations, the method may include receiving a request from a user device of a requesting user to join a particular virtual experience hosted on a virtual experience platform, identifying virtual experience instances of the particular virtual experience that are in progress, determining an initial set of virtual experience instances eligible for the requesting user to join, obtaining one or matchmaking scoring criteria that are associated with the particular virtual experience, determining a respective score for each individual virtual experience instance in the initial set of virtual experience instances based on the one or more matchmaking scoring criteria, determining, based on the respective scores, a candidate set of virtual experience instances, and causing the user device to connect to the server that hosts a particular virtual experience instance of the candidate set of virtual experience instances.

### CROSS REFERENCE TO RELATED APPLICATIONS

This application claims priority under 35 U.S.C. § 119 (e) to U.S. Provisional Patent Application No. 63/691,286, entitled “CUSTOMIZABLE MATCHMAKING FOR USERS OF ONLINE VIRTUAL EXPERIENCES,” filed on Sep. 5, 2024, and to U.S. Provisional Application No. 63/779,004, entitled “CUSTOMIZABLE MATCHMAKING OF USERS IN ONLINE VIRTUAL ENVIRONMENTS,” filed on Mar. 27, 2025. The contents of U.S. Provisional Patent Application Nos. 63/691,286 and 63/779,004 are incorporated herein in their entirety.

### TECHNICAL FIELD

This disclosure relates to the field of computerized networked service for games and other virtual experiences, and in particular but not exclusively, to methods, systems, and computer readable media for connecting players and user devices to virtual experiences on online computer platforms.

### BACKGROUND

Some online platforms allow users to join online games or other virtual experiences with other players via the Internet and/or other computer networks. Users of online experience platforms may participate in multiuser virtual environments such as multiplayer games in which games, parts of games, or other experiences have been created by developers (which can include other users). Some online platforms include a matchmaking service that receives a request from a player (or other user) to join an experience. For example, the matchmaking service identifies one or more currently-active experiences that are matched to the player's criteria or attributes, and connects the player to a matched experience and presents the player with options to join any of the matched experiences.

Online virtual experience platforms may offer a matchmaking service to enable users with similar characteristics or preferences to be grouped together in virtual experiences. Such a matchmaking service may use one set of matchmaking criteria used by all experiences on the platform. However, some developers of experiences may wish to change the matchmaking technique that is used for their experiences (e.g., modify criteria, characteristics, and/or options of matchmaking for their virtual experiences). For example, some developers may prefer to implement matchmaking based on a skill rating of players for their competitive experiences, but this option may not be offered by the platform matchmaking service, or may only be offered using fixed matchmaking criteria that do not satisfy the developer's needs. A developer may be able to implement their own matchmaking features for their virtual experiences, but such custom features are usually difficult and/or costly to implement, do not efficiently/efficiently use device resources, and/or cannot take full advantage of existing matchmaking algorithms on the online virtual experience platform.

The background description provided herein is to present the context of the disclosure. Work of the presently named inventors, to the extent it is described in this background section, as well as aspects of the description that may not otherwise qualify as prior art at the time of filing, are neither expressly nor impliedly admitted as prior art against the present disclosure.

### SUMMARY

Implementations relate to methods, systems, and computer-readable media to perform customized matchmaking. In some implementations, a computer-implemented method may include receiving a request from a user device of a requesting user to join a particular virtual experience of a plurality of virtual experiences hosted on a virtual experience platform, identifying virtual experience instances of the particular virtual experience that are in progress, each of the virtual experience instances executing on a respective server of the virtual experience platform, determining an initial set of virtual experience instances eligible for the requesting user to join, wherein the initial set of virtual experience instances is a subset of the identified virtual experience instances, obtaining one or matchmaking scoring criteria that are associated with the particular virtual experience, determining a respective score for each individual virtual experience instance in the initial set of virtual experience instances based on the one or more matchmaking scoring criteria, determining, based on the respective scores, a candidate set of virtual experience instances, wherein the candidate set of virtual experience instances is a subset of the initial set of virtual experience instances, and causing the user device to connect to the server that hosts a particular virtual experience instance of the candidate set of virtual experience instances.

In some implementations, the particular virtual experience instance of the candidate set of virtual experience instances is associated with a highest score of the respective scores.

In some implementations, obtaining the one or more matchmaking scoring criteria may include providing a user interface to a developer of the particular virtual experience to provide the one or more matchmaking scoring criteria, the user interface including information indicative of candidate attributes that can be specified in the one or more matchmaking scoring criteria, and receiving, via the user interface, developer input that specifies the one or more matchmaking scoring criteria, wherein each matchmaking scoring criteria includes at least one of the candidate attributes.

In some implementations, the matchmaking scoring criteria may include one or more attributes from the candidate attributes, and a respective weight for each of the one or more attributes. In some implementations, the method may further include, for each individual virtual experience instance in the initial set: computing, based on the matchmaking scoring criteria, a respective score associated with each of the one or more attributes, and computing the score for the individual virtual experience instance as a weighted sum of the respective scores associated with the one or more attributes.

In some implementations, the method may further include obtaining values for the one or more attributes included in the matchmaking scoring criteria for each of the initial set of virtual experiences.

In some implementations, the method may further include computing signal scores for each of the initial set of virtual experiences based on the obtained values for the one or more attributes included in the matchmaking scoring criteria.

In some implementations, computing the signal scores may include computing a function of the obtained values for the one or more attributes included in the matchmaking scoring criteria. In some implementations, the function is one of an increasing linear function and a decreasing linear function.

In some implementations, the one or more attributes may include a number of friends of the requesting user currently participating in the initial set of virtual experience instances, and the function may be a non-linear function.

In some implementations, the method may further include determining a join performance of the particular virtual experience, and providing a recommendation to a developer of the particular virtual experience based on the join performance.

In some implementations, the method may further include detecting a change in assets associated with the particular virtual experience, in response to detecting the change, providing an update user interface to a developer of the particular virtual experience to update the matchmaking scoring criteria, and receiving, via the update user interface, updated matchmaking scoring criteria for the particular virtual experience.

In some implementations, the matchmaking scoring criteria may include text input received from a developer of the particular virtual experience, and method may further include applying a trained machine learning (ML) model to the received text input to determine one or more weights or signals.

In some implementations, a non-transitory computer-readable medium with instructions stored thereon that, upon execution by a processing device, cause the processing device to perform operations that include receiving a request from a user device of a requesting user to join a particular virtual experience of a plurality of virtual experiences hosted on a virtual experience platform, identifying virtual experience instances of the particular virtual experience that are in progress, each of the virtual experience instances executing on a respective server of the virtual experience platform, determining an initial set of virtual experience instances eligible for the requesting user to join, wherein the initial set of virtual experience instances is a subset of the identified virtual experience instances, obtaining one or matchmaking scoring criteria that are associated with the particular virtual experience, determining a respective score for each individual virtual experience instance in the initial set of virtual experience instances based on the one or more matchmaking scoring criteria, determining, based on the respective scores, a candidate set of virtual experience instances, wherein the candidate set of virtual experience instances is a subset of the initial set of virtual experience instances, and causing the user device to connect to the server that hosts a particular virtual experience instance of the candidate set of virtual experience instances.

In some implementations, a system may include a memory with instructions stored thereon, and a processing device, coupled to the memory, the processing device configured to access the memory and execute the instructions, wherein the instructions cause the processing device to perform operations that include receiving a request from a user device of a requesting user to join a particular virtual experience of a plurality of virtual experiences hosted on a virtual experience platform, identifying virtual experience instances of the particular virtual experience that are in progress, each of the virtual experience instances executing on a respective server of the virtual experience platform, determining an initial set of virtual experience instances eligible for the requesting user to join, wherein the initial set of virtual experience instances is a subset of the identified virtual experience instances, obtaining one or matchmaking scoring criteria that are associated with the particular virtual experience, determining a respective score for each individual virtual experience instance in the initial set of virtual experience instances based on the one or more matchmaking scoring criteria, determining, based on the respective scores, a candidate set of virtual experience instances, wherein the candidate set of virtual experience instances is a subset of the initial set of virtual experience instances, and causing the user device to connect to the server that hosts a particular virtual experience instance of the candidate set of virtual experience instances.

### BRIEF DESCRIPTION OF THE DRAWINGS

FIG. 1 is a diagram of an example environment to perform customized matchmaking for users of virtual experiences, in accordance with some implementations.

FIG. 2A is a diagram of an example method to provide developer-customized matchmaking of players to virtual experiences, according to one or more implementations.

FIG. 2B is a diagram of another example method to provide developer-customized matchmaking of players to virtual experiences, according to one or more implementations.

FIG. 2C is a diagram of another example method to provide developer-customized matchmaking of players to virtual experiences, according to one or more implementations.

FIG. 3 is a diagram that depicts a system architecture of a customized matchmaking system from the perspective of a developer of virtual experiences on a virtual experience platform, in accordance with some implementations.

FIG. 4A is a diagram showing a system architecture of a customized matchmaking system from a perspective of a user that requests to join a virtual experience hosted on a virtual experience platform.

FIG. 4B is a diagram that depicts another system architecture of a customized matchmaking system.

FIG. 5 is a diagram of an example method to provide evaluation and filtering of eligible game instances based on developer-defined rules, according to one or more implementations.

FIG. 6 is a block diagram of an example virtual experience platform engine that maintains server attributes and player attributes data in memory.

FIG. 7 illustrates an example method to perform customized matchmaking for users of virtual experiences based on developer provided matchmaking rules, in accordance with some implementations.

FIG. 8 illustrates an example method to perform customized matchmaking for users of virtual experiences based on developer provided matchmaking scoring criteria, in accordance with some implementations.

FIG. 9 illustrates an example method to perform customized matchmaking for users of virtual experiences based on developer provided matchmaking rules and developer provided matchmaking scoring criteria, in accordance with some implementations.

FIG. 10A illustrates a user interface layout that may be utilized by a developer of a virtual experience to customize matchmaking attributes for the virtual experience, in accordance with some implementations.

FIG. 10B illustrates a user interface layout that may be utilized by a developer of a virtual experience to add new player attributes for use in customized matchmaking, in accordance with some implementations.

FIG. 10C illustrates a user interface layout that may be utilized by a developer of a virtual experience to add server rules for use in customized matchmaking, in accordance with some implementations.

FIG. 11 illustrates a user interface layout that may be utilized by a developer of a virtual experience to configure a new attribute for use in customized matchmaking, in accordance with some implementations.

FIG. 12 illustrates a user interface layout that may be utilized by a developer of a virtual experience to provide matchmaking scoring criteria for use in customized matchmaking, in accordance with some implementations.

FIG. 13 illustrates a user interface layout that may be utilized by a developer of a virtual experience to provide additional matchmaking scoring criteria for use in customized matchmaking, in accordance with some implementations.

FIG. 14 illustrates an example computing device, in accordance with some implementations.

### DETAILED DESCRIPTION

One or more implementations described herein relate to customizable matchmaking for users of online virtual experiences.

The terms “experience” or “virtual experience” or “game,” as used herein, refer to any virtual experience in a computer (virtual) environment, including games with specified objectives or end states, as well as other types of virtual experiences such as concerts, meetings, virtual gatherings of users, etc. that may not have a specific objective or end state. While various descriptions of games, game functionality, and players are included herein, they are illustrative examples, and that the features disclosed herein can be adapted to virtual environments and related functionality and their users, which may not necessarily involve games.

An “experience instance,” “game instance,” or “instance” refers to a specific, independently executing session or instance of an experience running on a server. An instance can include its own set of players/users, and multiple instances of an experience can be executing separately and independently on one or more servers. A server refers to the physical or virtual machine hosting one or more experience instances (a “server attribute” may refer to an attribute of an instance executing on a server).

There may exist a need for improved customization of matchmaking features of a matchmaking service of a virtual experience platform (or other system) for experiences (e.g., games or other experiences) offered on that platform. Currently, some platform matchmaking services operate on a one-size-fits-all principle, utilizing the same matchmaking algorithm for all experiences such as games. The service may operate by first selecting a set of currently running game instances to score then scoring these instances using a matchmaking algorithm. This algorithm is well-tuned for matching players of certain types of experiences, but there may be a variety of experiences available with diverse matchmaking needs. Some developers may develop custom matchmaking solutions to address their specific needs, but that solution comes with many challenges.

A limitation in some matchmaking services is that using the exact same algorithm is not equally suitable for every experience. For example, a matchmaking service may place new players into already running instances relying primarily on social signals like friends, instance occupancy, and preferred language. This doesn't work as well for experiences with diverse matchmaking needs that differ from this approach, such as competitive games. For example, scoring that emphasizes social signals may be detrimental to find matching players in certain types of games like competitive games. Examples of other matchmaking needs include simultaneous joins (all players being present to start a match); skill-based matchmaking (players to be matched based on their in-game level or skill rating); and latency sensitivity (particular experiences, such as real time action games, may have greater emphasis on certain signals such as instance/server latency to a player).

This mismatch may result in developers creating their own custom matchmaking solutions. However, such custom matchmaking solutions are typically burdensome for developers to create themselves and/or costly when using existing products from third parties.

Described features include the ability of developers to configure matchmaking for their experience instances (e.g., by specifying attributes and matchmaking rules). For example, developers can assign specific attributes to players and instances. For example, these attributes can include player skill ratings or levels (e.g., Elo ratings), play modes, etc. The developer also defines matchmaking rules that make use of the attributes. The rules determine which instances are suitable for specific players. Once the rules are defined for an experience, the matchmaking system automatically selects eligible instances of that experience that meet the criteria specified in the rules. For example, the existing matchmaking scoring algorithm can score the eligible instances based on additional characteristics or factors and choose the best instance among these eligible instances, after which the requesting user is joined to the top scoring instance. When the rules result in no instances being eligible, the matchmaking system may consider an expanded criteria set for each rule as defined by the developer, followed by setting optional rules (as defined by the developer) if no eligible instances continue to be found.

Described features offer developers the ability to customize how players are matched within their games. Developer customized matchmaking allows developers to have some level of control over the matchmaking process via matchmaking rules and attributes. Customized matchmaking enables developers to unlock use cases that are not possible or extremely difficult to achieve, such as skill-based matchmaking and multiple game/play modes, thus improving the general matchmaking quality for their experiences. Developers thus can have the ability to match players into instances in player-satisfying ways for their experiences.

Described features provide a developer of experiences on an online experience platform with the ability to match players into appropriate instances of their experiences via a customized matchmaking system.

In some implementations, creators are enabled to customize eligibility of instances to be scored by the matchmaking algorithm (not the scoring algorithm itself). Creators can define a set of custom matchmaking rules that influence an instance eligibility filtering step in the matchmaking process, which may be separate and independent from a core scoring algorithm to determine matches. In such implementations, the core scoring algorithm can remain unchanged.

Using a custom instance-eligibility filter (intermediate customization filter) provides advantages, such as preserving the integrity of the existing matchmaking scoring algorithm, allowing flexibility for future modifications of the scoring by the platform. It also provides creators comprehensive opportunities through instance eligibility selection as the primary lever for customization. It addresses developer needs comprehensively, maintains the platform's ability to rapidly iterate on the matchmaking scoring algorithm, and is compatible with most industry standards.

Furthermore, by allowing developers to control instance eligibility instead of matchmaking scoring, developers are still able to the use the matchmaking scoring from the platform, which is a substantive part of the matchmaking process because the scoring algorithm is able to take into account a number of other signals; thus the developer can take advantage of the platform's matchmaking process that is continually tuned for more accuracy and player satisfaction using a honed set of signals in the scoring.

In some other implementations, creators are enabled to customize the scoring algorithm itself by defining customized matchmaking scoring criteria. Creators can define a set of attributes, signals, and/or weights for the signals or attributes, and directly influence the scoring algorithm to determine matches.

Described features may include scoring techniques for customized matchmaking whereby a developer user is enabled to adjust and influence matchmaking scoring algorithm, and empower developers to build competitive, cooperative, and unique experiences that enhance player engagement and satisfaction. The scoring customization feature serves as a foundational component of the broader custom matchmaking and is aimed at enabling creators to influence how matchmaking decisions are made in their games/experiences.

Techniques described herein enable creators to use platform-defined attributes (e.g., latency, language, friends) alongside custom attributes (e.g., skill, game mode preference) as key scoring inputs. They also enable creators to adjust relative weights of attributes to influence matchmaking decisions.

Using the features described herein, developers providing experiences on a virtual experience platform are able to specifically narrow down eligible experiences to a smaller set of instances that match their criteria for players joining, and which matches closely their designs for players of their experiences. Described customization tools provide a large range of flexibility to developers; instance eligibility can be highly expressive. Furthermore, described customization tools support a wide range of use cases beyond customizing matchmaking, such as stopping joins into particular instances or servers. Furthermore, unlike ranking, eligibility may be a yes/no decision that does not involve making tradeoffs against other factors outside the developer's knowledge (e.g., understanding how the matchmaking scoring algorithm works and the signals that go into it). Furthermore, eligibility criteria can be defined, evaluated, and applied independently. For example, it may be easy to separately apply both developer-defined eligibility criteria and also those scoring criteria defined by the platform and its matchmaking system without either party having knowledge or consideration of the other's criteria. Furthermore, eligibility is very clear to implement for developers. For example, the resulting outcomes of implementing custom matchmaking rules are easily discerned by developers so they can learn and improve.

Furthermore, the custom instance-eligibility filter removes the need for developers to customize and modify signals within a core matchmaking scoring algorithm (e.g., that is offered by the virtual experience platform). This allows the platform to maintain the core matchmaking algorithm separate from developer modifications. Allowing developer modification of signals used in the core scoring algorithm may limit the platform's agility in modifying and improving the scoring algorithm, since the developer may change various scoring criteria for their own experiences. Furthermore, allowing such modification of the scoring algorithm may limit addressing the diverse range of matchmaking needs of developers by not offering sufficient granularity in the types of signals that developers would like to use for their specific experiences, may not address all major use cases developers have for customized matchmaking, and/or may cause the scoring algorithm to not provide accurate or consistent results and/or not be compatible with existing scoring techniques (e.g., machine learning based scoring algorithms). For example, developers might unintentionally cause negative impacts to experience metrics, platform metrics, and/or matchmaking improvement due to poor implementation of developer modifications to the matchmaking algorithms.

Thus, in some implementations, developers can influence matchmaking via instance filtering, but not matchmaking scoring. Developers have control over customizing instance eligibility but no direct control over the scoring algorithm. This allows the platform to maintain its ability to iterate on the scoring algorithm, but still gives developers significant freedom to build matchmaking for their experiences.

Described features enable developers to define custom matchmaking rules, using custom player attributes and server attributes as inputs. Described features enable the defining of custom rules and attributes to be easy with a simple developer matchmaking user interface.

Enabling developers with tools to customize matchmaking unlocks new content types that do not already exist on an online platform. For example, if experiences on a platform skew towards social games, custom matchmaking allows competitive games to be easily offered by developers, including matchmaking based on a skill rating or experience of players. Experiences may be easy to create, and this case can include creation of matchmaking services that emphasize social or competitive matchmaking signals as appropriate to the experience.

Customizing matchmaking also benefits the engagement of players with experiences. For example, described customization features allow simple level brackets to be provided for casual-oriented instances of an experience, and skill-based matchmaking to be provided for ranked competitive instances of that same experience. This improves retention of players in experiences, particularly for new players, and improves player engagement as a result.

Features described herein provide computationally efficient determination of instances that requesting users can join and will want to remain connected to. For example, the matchmaking provided herein can alleviate the computationally wasteful process (also wasteful of network bandwidth) of users joining incompatible or inappropriate instances, quitting those instances, joining other instances, etc., repeatedly until an instance appropriate to their needs is found. In some cases, described features allow instantaneous joins of requesting users to instances without waiting for an available instance. Described features enable developers to implement their experiences without needing to worry about how to implement custom matchmaking or instance management themselves.

Described features allow customization of matchmaking but do not expose sensitive or personal data of users of the platform to developers that use the custom matchmaking system. For example, developers do not have access to potentially sensitive or personally identifying player data, such as player age. For example, in some implementations, a platform may make use of player data (if player consent has been obtained) in matchmaking scoring algorithms, but developers do not have access to the matchmaking scoring algorithms used by the platform.

The platform also can establish guardrails that safeguard against harmful configurations of matchmaking. The platform can implement measures to make it challenging for developers to define configurations that harm players or the platform while supporting diverse use cases.

Described features can include customized matchmaking having high flexibility with low complexity. Described systems can balance expressiveness in customization and complexity to provide a user-friendly experience for developers. For example, tagging instances with attributes can enable casual/ranked play, different game modes, and different instance skill ratings (bronze, silver, gold).

In some implementations, a play button (e.g., join command) can provide instant join of the user to an instance of the requested experience. Instant access to experiences is provided upon selection of the play button or join button, instead of having to wait to join an available experience. This ensures a seamless entry into experiences, without any additional friction in joining an experience due to matchmaking.

Example experiences that make use of customized matchmaking (use cases):

Play Modes: An experience may have different modes of play, which are typically selected by the player and mutually exclusive. Each instance of an experience can have a play mode different from or independent of the other instances of that experience. Players in each play mode only play with others playing the same play mode. Examples: solo vs duos vs squads, casual vs ranked, roleplay vs combat, duels vs free-for-all (FFA) vs team. In some implementations, an exact match rule can be evaluated between the player and the instances to ensure the player is joined with an instance having the preferred play mode.

Individually Matchmade Round Based Games: A game in which an instance is created, a set of players connect, these players complete a single match or game, then all players are returned to a lobby or new instance. Players play a single match with one another and a specific number of players start a round. Thus, players all join at the same time at the beginning of a match. Generally, many competitive multiplayer games adopt this model; many experiences have large lobbies and matchmake within lobbies, and players wait in-experience until the correct number of players are in the instance. Using described features, players can queue to join a particular game mode, ensuring that all players join simultaneously. Developers can set any number of rules to ensure sets of players with similar preferences are grouped together in each instance. For example, this can be combined with skill-based matchmaking and/or latency sensitive matchmaking.

Continuous Round-Based Games: A game occurs in rounds or matches, but players remain with the same set of players across matches until they choose to leave. Newly joining players may join as spectators until the current round of play is complete. Often, multiplayer games that are less competitive or less competitive game modes may adopt this model. On some platforms, more competitive game modes may generally matchmake within a lobby. Using described features, any number of eligibility criteria may be set depending on the developer's preferences, including tighter latency requirements or matching players with similar skill to one another.

Skill Based Matchmaking (SBMM): A game in which players may prefer to play with players of a similar skill or experience level to themselves. The skill-based signal is typically used in one of three ways:
Bucketing. Players can only play against others in the same rank bucket. For example, an experience may have bronze, silver, etc. instances where players can only join when they are in that rank bucket.
Grouping. Players are grouped together so that the range of skill is within a tolerable boundary. Most online games with competitive matchmaking use this.
Scoring. The signal is an input for the matchmaking score. There is no guarantee on skill range between players.

Generally, competitive multiplayer games use skill-based matchmaking. On some platforms, matchmaking must occur within a lobby. Using described features, an exact match rule or max difference rule can be set for player rank, skill, or experience. Depending on a developer's implementation, players of the same rank (e.g., silver) might match together, the same experience levels (e.g., levels 45-60 within the experience) match together, or players with similar Elo scores (e.g., 1450 & 1500) match together.

Latency Sensitive Games: Many experiences specify that players have low latency in order to have a good gameplay experience. These experiences generally have fast-paced action. Most shooters fall within this category. These experiences tend to be more gameplay-oriented and less social. On some platforms, developers rely on the matchmaking process of the platform to produce low-ping instances for their players, for example, by matchmaking within lobby instances. Custom implementations may use the player's region as a proxy for their ping and try to match players within the same region together. Using described features, latency tolerance of an experience instance can be changed from default to strict. The platform may automatically prioritize low latency instances during the eligibility phase of matchmaking.

Stop Joins: A condition in which an instance may be marked as ineligible for matchmaking. Example: Immediately prior to an update or when the instance is in the middle of an existing round. Using described features, developers can set a boolean toggle for each instance that triggers, to cause the instance to be joinable or not, whether or not the instance is joinable by the usual matchmaking scoring algorithms.

Techniques described herein can improve the efficiency of matchmaking in virtual environments, improve user experience, and provide additional technical advantages. For example, the techniques may lead to an improved join rate of users to virtual experiences, greater server utilization, less reconnection of users to the platform's servers thereby saving network resources, etc.

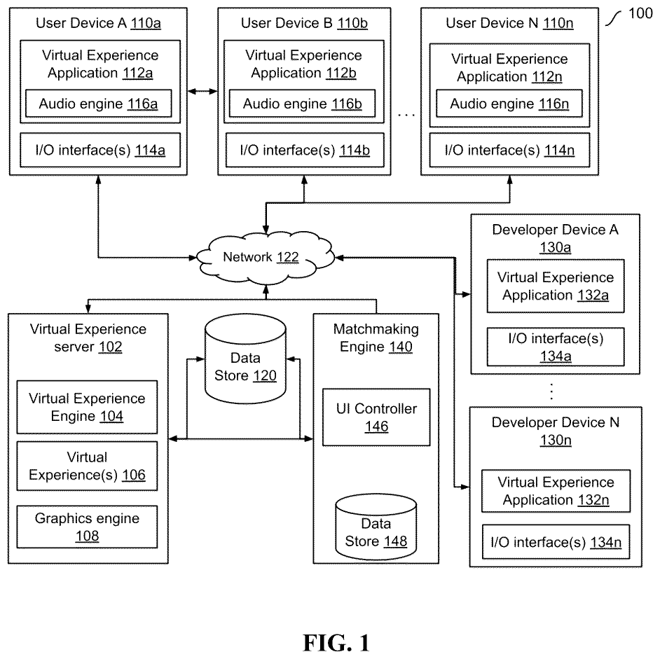

FIG. 1 is a diagram of an example environment to perform customized matchmaking for users of virtual experiences, in accordance with some implementations. FIG. 1 and other figures use like reference numerals to identify like elements. A letter after a reference numeral, such as “110,” indicates that the text refers specifically to the element having that particular reference numeral. A reference numeral in the text without a following letter, such as “110,” refers to any or all of the elements in the figures bearing that reference numeral (e.g. “110” in the text refers to reference numerals “110a,” “110b,” and/or “110n” in the figures).

The system architecture for virtual experience platform 100 (also referred to as “system” herein) includes online virtual experience server 102, data store 120, user devices 110a, 110b, and 110n (generally referred to as “user device(s) 110” herein), developer devices 130a and 130n (generally referred to as “developer device(s) 130” herein), and matchmaking engine 140, coupled via network 122. In some implementations, user devices(s) 110 and developer device(s) 130 may refer to the same or same type of device.

Online virtual experience server 102 can include a virtual experience engine 104, one or more virtual experience(s) 106, and graphics engine 108. A user device 110 can include a virtual experience application 112, and input/output (I/O) interfaces 114 (e.g., input/output devices). The input/output devices can include one or more of a microphone, speakers, headphones, display device, mouse, keyboard, game controller, touchscreen, virtual reality consoles, etc. The input/output devices can also include accessory devices that are connected to the user device by means of a cable (wired) or that are wirelessly connected.

Matchmaking engine 140 can include a user interface (UI) controller 146. In some implementations, the matchmaking engine may include or reside in a plurality of servers, and/or portions of its functionality may be implemented in user devices 110 or developer devices 130. The matchmaking engine 140 may be implemented as software or other computer-readable instructions stored on at least one computer-readable medium and executed by one or more processors.

A developer device 130 can include a virtual experience application 132, and input/output (I/O) interfaces 134 (e.g., input/output devices). The input/output devices can include one or more of a microphone, speakers, headphones, display device, mouse, keyboard, game controller, touchscreen, virtual reality consoles, etc.

System architecture for the virtual experience platform 100 is provided for illustration. In different implementations, the system architecture for the virtual experience platform 100 may include the same, fewer, more, or different elements configured in the same or different manner as that shown in FIG. 1.

In some implementations, network 122 may include a public network (e.g., the Internet), a private network (e.g., a local area network (LAN) or wide area network (WAN)), a wired network (e.g., ethernet network), a wireless network (e.g., an 802.11 network, a Wi-Fi® network, or wireless LAN (WLAN)), a cellular network (e.g., a 5G network, a long term evolution (LTE) network, etc.), routers, hubs, switches, server computers, or a combination thereof.

In some implementations, the data store 120 may be a non-transitory computer readable memory (e.g., random access memory), a cache, a drive (e.g., a hard drive), a flash drive, a database system, a cloud storage system, or another type of component or device capable of storing data. The data store 120 may also include multiple storage components (e.g., multiple drives or multiple databases) that may also span multiple computing devices (e.g., multiple server computers).

In some implementations, the online virtual experience server 102 can include a server having one or more computing devices (e.g., a cloud computing system, a rackmount server, a server computer, cluster of physical servers, etc.). In some implementations, the online virtual experience server 102 may be an independent system, may include multiple servers, or be part of another system or server.

In some implementations, the online virtual experience server 102 may include one or more computing devices (such as a rackmount server, a router computer, a server computer, a personal computer, a mainframe computer, a laptop computer, a tablet computer, a desktop computer, a distributed computing system, a cloud computing system, etc.), data stores (e.g., hard disks, memories, databases), networks, software components, and/or hardware components that may be used to perform operations on the online virtual experience server 102 and to provide a user with access to online virtual experience server 102. The online virtual experience server 102 may also include a website (e.g., a web page) or application back-end software that may be used to provide a user with access to content provided by online virtual experience server 102. For example, users may access online virtual experience server 102 using the virtual experience application 112 on user devices 110.

In some implementations, online virtual experience server 102 may be a type of social network providing connections between users or a type of user-generated content system that allows users (e.g., end-users or consumers) to communicate with other users on the online virtual experience server 102, where the communication may include voice chat (e.g., synchronous and/or asynchronous voice communication), video chat (e.g., synchronous and/or asynchronous video communication), or text chat (e.g., synchronous and/or asynchronous text-based communication). In some implementations of the disclosure, a “user” may be represented as a single individual. However, other implementations of the disclosure encompass a “user” (e.g., creating user) being an entity controlled by a set of users or an automated source. For example, a set of individual users federated as a community or group in a user-generated content system may be considered a “user.” In some contexts, a user may be a system administrator or other entity that has privileges/permissions that are different from and/or in addition to an end user.

In some implementations, online virtual experience server 102 may be an online gaming server. For example, the virtual experience server may provide single-player or multiplayer games to a community of users that may access or interact with games using user devices 110 via network 122. In some implementations, games (also referred to as “video game,” “online game,” or “virtual game” herein) may be two-dimensional (2D) games, three-dimensional (3D) games (e.g., 3D user-generated games), virtual reality (VR) games, or augmented reality (AR) games, for example. In some implementations, users may participate in gameplay with other users. In some implementations, a game may be played in real-time with other users of the game.

In some implementations, gameplay may refer to the interaction of one or more players using user devices (e.g., 110) within a game (e.g., game that is part of virtual experience 106) or the presentation of the interaction on a display or other output device (e.g., 114) of a user device 110.

In some implementations, a virtual experience 106 can include an electronic file that can be executed or loaded using software, firmware or hardware configured to present the game content (e.g., digital media item) to an entity. In some implementations, a virtual experience application 112 may be executed and a virtual experience 106 executed in connection with a virtual experience engine 104. In some implementations, a virtual experience 106 such as a game may have a common set of rules or common goal, and the environment of a virtual experience 106 shares the common set of rules or common goal. In some implementations, different games may have different rules or goals from one another.

In some implementations, virtual experience(s) may have one or more environments (also referred to as “gaming environments” or “virtual environments” herein) where multiple environments may be linked. An example of an environment may be a three-dimensional (3D) environment. The one or more environments of a virtual experience application 112 may be collectively referred to a “world” or “gaming world” or “virtual world” or “universe” herein. An example of a world may be a 3D world of a virtual experience 106. For example, a user may build a virtual environment that is linked to another virtual environment created by another user. A character of the virtual game may cross the virtual border to enter the adjacent virtual environment.

It may be noted that 3D environments or 3D worlds use graphics that use a three-dimensional representation of geometric data representative of game content (or at least present game content to appear as 3D content whether or not 3D representation of geometric data is used). 2D environments or 2D worlds use graphics that use two-dimensional representation of geometric data representative of game content.

In some implementations, the online virtual experience server 102 can host one or more virtual experiences 106 and can permit users to interact with the virtual experiences 106 using a virtual experience application 112 of user devices 110. Users of the online virtual experience server 102 may play, create, interact with, or build virtual experiences 106, communicate with other users, and/or create and build objects (e.g., also referred to as “item(s)” or “game objects” or “virtual game item(s)” herein) of virtual experiences 106. For example, in generating user-generated virtual items, users may create characters, decoration for the characters, one or more virtual environments for an interactive game, or build structures used in a game. In some implementations, users may buy, sell, or trade virtual game objects, such as in-platform currency (e.g., virtual currency), with other users of the online virtual experience server 102. In some implementations, online virtual experience server 102 may transmit game content to virtual experience applications (e.g., 112). In some implementations, game content (also referred to as “content” herein) may refer to any data or software instructions (e.g., game objects, game, user information, video, images, commands, media item, etc.) associated with online virtual experience server 102 or virtual experience applications. In some implementations, game objects (e.g., also referred to as “item(s)” or “objects” or “virtual objects” or “virtual game item(s)” herein) may refer to objects that are used, created, shared or otherwise depicted in virtual experiences 106 of the online virtual experience server 102 or virtual experience applications 112 of the user devices 110. For example, game objects may include a part, model, character, accessories, tools, weapons, clothing, buildings, vehicles, currency, flora, fauna, components of the aforementioned (e.g., windows of a building), and so forth.

It may be noted that the online virtual experience server 102 hosting virtual experiences 106, is provided for purposes of illustration, rather than limitation. In some implementations, online virtual experience server 102 may host one or more media items that can include communication messages from one user to one or more other users. Media items can include, but are not limited to, digital video, digital movies, digital photos, digital music, audio content, melodies, website content, social media updates, electronic books, electronic magazines, digital newspapers, digital audio books, electronic journals, web blogs, real simple syndication (RSS) feeds, electronic comic books, software applications, etc. In some implementations, a media item may be an electronic file that can be executed or loaded using software, firmware or hardware configured to present the digital media item to an entity.

In some implementations, a virtual application 106 may be associated with a particular user or a particular group of users (e.g., a private game), or made widely available to users with access to the online virtual experience server 102 (e.g., a public game). In some implementations, where online virtual experience server 102 associates one or more virtual experiences 106 with a specific user or group of users, online virtual experience server 102 may associate the specific user(s) with a virtual experience 106 using user account information (e.g., a user account identifier such as username and password).

The virtual experience platform 100 may also include a matchmaking engine 140, including features that enable a developer to customize matchmaking of players to virtual experience instances as described herein. In some implementations, the matchmaking engine 140 can be implemented at least in part by or on one or more processors of the virtual experience platform 100. Matchmaking engine 140 can be used to provide experience instances to a requesting user that may be suitable for the user to join, based on one or more attributes of the user, players, and instances. For example, the user may input a request to the virtual experience platform to be presented with virtual experiences 106 that the user can currently join. The request can also include a search term for, or specification of, a particular virtual experience 106 available on the virtual experience platform 100 that the user desires to join.

Matchmaking engine 140 may be utilized to search for experience instances in response to the virtual experience platform 100 receiving a request from a user to join a specified experience at or soon after the request is received. These can be instances that, at the time of the request, allow one or more players to join those instances, e.g., are active (executing) at the time of the user join request (currently active). In some examples, the currently active game instances can be implementing the experience such that one or more other existing players are currently connected to the experience (e.g., playing the game) and one or more other players can join the instance. In some implementations or cases, active instances can implement queues or lobbies where one or more players are waiting for one or more other players to join the instance that will cause the instance to initiate.

Matchmaking engine 140 can employ a matchmaking process to determine which eligible (available) experience instances currently executing on the virtual experience platform 100 are a match for the requesting user. Matchmaking engine 140 can be utilized to determine eligible instances based on several steps as described herein, including filtering based on developer-defined matchmaking rules. In some implementations, matchmaking engine 140 can find top scoring instances, and one or more of those instances can be presented to the requesting user with the option to join any of them or the requesting user can be automatically joined to a top scoring instance as a player. Matchmaking engine 140 can be utilized to provide as output determined matched instance(s) which can be presented to the user and/or the user can be connected to a matched virtual experience instance. Further example details of matchmaking engine 140 and a matchmaking system for use in virtual experience platforms are described herein.

In some implementations, a matchmaking user interface is provided by platform 100 and displayed by client devices 110 to allow a developer to specify attributes, rules, and other parameters of customized matchmaking. In some implementations, online virtual experience server 102 or user devices 110 may include a virtual experience engine 104 or virtual experience application 112 respectively. In some implementations, virtual experience engine 104 may be used for the development or execution of virtual experiences 106. For example, virtual experience engine 104 may include a rendering engine (“renderer”) for 2D, 3D, VR, or AR graphics, a physics engine, a collision detection engine (and collision response), sound engine, scripting functionality, animation engine, artificial intelligence engine, networking functionality, streaming functionality, memory management functionality, threading functionality, scene graph functionality, or video support for cinematics, among other features. The components of the virtual experience engine 104 may generate commands that help compute and render the game (e.g., rendering commands, collision commands, physics commands, etc.) In some implementations, virtual experience applications 112 of user devices 110, may work independently, in collaboration with virtual experience engine 104 of online virtual experience server 102, or a combination of both.

In some implementations, both the online virtual experience server 102 and user devices 110 may execute a virtual experience engine and a virtual experience application (104 and 112, respectively). The online virtual experience server 102 using virtual experience engine 104 may perform some or all the virtual experience engine functions (e.g., generate physics commands, rendering commands, etc.), or offload some or all the virtual experience engine functions to virtual experience engine 104 of user device 110. In some implementations, each virtual application 106 may have a different ratio between the virtual experience engine functions that are performed on the online virtual experience server 102 and the virtual experience engine functions that are performed on the user devices 110. For example, the virtual experience engine 104 of the online virtual experience server 102 may be used to generate physics commands in cases where there is a collision between at least two virtual application objects, while the additional virtual experience engine functionality (e.g., generate rendering commands) may be offloaded to the user device 110. In some implementations, the ratio of virtual experience engine functions performed on the online virtual experience server 102 and user device 110 may be changed (e.g., dynamically) based on gameplay conditions. For example, if the number of users participating in gameplay of a particular virtual application 106 exceeds a threshold number, the online virtual experience server 102 may perform one or more virtual experience engine functions that were previously performed by the user devices 110.

For example, users may be playing a virtual application 106 on user devices 110, and may send control instructions (e.g., user inputs, such as right, left, up, down, user election, or character position and velocity information, etc.) to the online virtual experience server 102. Subsequent to receiving control instructions from the user devices 110, the online virtual experience server 102 may send gameplay instructions (e.g., position and velocity information of the characters participating in the group gameplay or commands, such as rendering commands, collision commands, etc.) to the user devices 110 based on control instructions. For instance, the online virtual experience server 102 may perform one or more logical operations (e.g., using virtual experience engine 104) on the control instructions to generate gameplay instruction(s) for the user devices 110. In other instances, online virtual experience server 102 may pass one or more or the control instructions from one user device 110 to other user devices (e.g., from user device 110a to user device 110b) participating in the virtual application 106. The user devices 110 may use the gameplay instructions and render the gameplay for presentation on the displays of user devices 110.

In some implementations, the control instructions may refer to instructions that are indicative of in-game actions of a user's character. For example, control instructions may include user input to control the in-game action, such as right, left, up, down, user selection, gyroscope position and orientation data, force sensor data, etc. The control instructions may include character position and velocity information. In some implementations, the control instructions are sent directly to the online virtual experience server 102. In other implementations, the control instructions may be sent from a user device 110 to another user device (e.g., from user device 110b to user device 110n), where the other user device generates gameplay instructions using the local virtual experience engine 104. The control instructions may include instructions to play a voice communication message or other sounds from another user on an audio device (e.g., speakers, headphones, etc.), for example voice communications or other sounds generated using the audio spatialization techniques as described herein.

In some implementations, gameplay instructions may refer to instructions that allow a user device 110 to render gameplay of a game, such as a multiplayer game. The gameplay instructions may include one or more of user input (e.g., control instructions), character position and velocity information, or commands (e.g., physics commands, rendering commands, collision commands, etc.).

In some implementations, the online virtual experience server 102 may store characters created by users in the data store 120. In some implementations, the online virtual experience server 102 maintains a character catalog and game catalog that may be presented to users. In some implementations, the game catalog includes images of virtual experiences stored on the online virtual experience server 102. In addition, a user may select a character (e.g., a character created by the user or other user) from the character catalog to participate in the chosen game. The character catalog includes images of characters stored on the online virtual experience server 102. In some implementations, one or more of the characters in the character catalog may have been created or customized by the user. In some implementations, the chosen character may have character settings defining one or more of the components of the character.

In some implementations, a user's character can include a configuration of components, where the configuration and appearance of components and more generally the appearance of the character may be defined by character settings. In some implementations, the character settings of a user's character may at least in part be chosen by the user. In other implementations, a user may choose a character with default character settings or character setting chosen by other users. For example, a user may choose a default character from a character catalog that has predefined character settings, and the user may further customize the default character by changing some of the character settings (e.g., adding a shirt with a customized logo). The character settings may be associated with a particular character by the online virtual experience server 102.

In some implementations, the virtual experience platform may support three-dimensional (3D) objects that are represented by a 3D model and includes a surface representation used to draw the character or object (also known as a skin or mesh) and a hierarchical set of interconnected bones (also known as a skeleton or rig). The rig may be utilized to animate the object and to simulate motion of the object. The 3D model may be represented as a data structure, and one or more parameters of the data structure may be modified to change various properties of the character (e.g., dimensions (height, width, girth, etc.); shape; movement style; number/type of parts; proportion, etc.).

In some implementations, the 3D model may include a 3D mesh. The 3D mesh may define a three-dimensional structure of the unauthenticated virtual 3D object. In some implementations, the 3D mesh may also define one or more surfaces of the 3D object. In some implementations, the 3D object may be a virtual avatar (e.g., a virtual character such as a humanoid character, an animal-character, a robot-character, etc.).

In some implementations, a platform may enable users to submit (upload) candidate 3D objects for utilization on the platform. A virtual experience development environment (developer tool) may be provided by the platform, in accordance with some implementations. The virtual experience development environment may provide a user interface that enables a developer user to design and/or create virtual experiences (e.g. games). The virtual experience development environment may be a client-based tool (e.g., downloaded and installed on a client device, and operated from the client device), a server-based tool (e.g., installed and executed at a server that is remote from the client device, and accessed and operated by the client device), or a combination of both client-based and service-based elements.

The virtual experience development environment may be operated by a developer of a virtual experience (e.g., a game developer or any other person who seeks to create a virtual experience that may be published by an online virtual experience platform and utilized by others). The user interface of the virtual experience development environment may be rendered on a display screen of a client device (e.g., such as a developer device 130 described with reference to FIG. 1), so as to enable the creator/developer to interact with the development environment using actions such as typing, highlighting, selecting, drag and drop, clicking, and so forth via a mouse, keyboard, or other input device configured to communicate with the user interface. The user interface may include a menu bar, a tool bar, a workspace pane, and a plurality of secondary panes. Depending on the particular implementation, the user interface may include alternative or additional elements, arrangements, operational features, etc. of the virtual experience development environment than what is shown and described herein.

A developer user (creator) may utilize the virtual experience development environment to create virtual experiences. As part of the development process, the developer/creator may upload various types of digital content such as object files (meshes), image files, audio files, short videos, etc., to enhance the virtual experience.

In implementations where the 3D object is an accessory, data indicative of use of the object in a virtual experience may also be received. For example, a “shoe” object may include annotations indicating that the object can be depicted as being worn on the feet of a virtual humanoid character, while a “shirt” object may include annotations that it may be depicted as being worn on the torso of a virtual humanoid character.

In some implementations, the 3D model may further include texture information associated with the 3D object. For example, texture information may indicate color and/or pattern of an outer surface of the 3D object. The texture information may enable varying degrees of transparency, reflectiveness, degrees of diffusiveness, material properties, and refractory behavior of the textures and meshes associated with the 3D object. Examples of textures include plastic, cloth, grass, a pane of light blue glass, ice, water, concrete, brick, carpet, wood, etc.

In some implementations, the user device(s) 110 may each include computing devices such as personal computers (PCs), mobile devices (e.g., laptops, mobile phones, smart phones, tablet computers, or netbook computers), network-connected televisions, gaming consoles, etc. In some implementations, a user device 110 may also be referred to as a “client device.” In some implementations, one or more user devices 110 may connect to the online virtual experience server 102 at any given moment. It may be noted that the number of user devices 110 is provided as illustration. In some implementations, any number of user devices 110 may be used.

In some implementations, each user device 110 may include an instance of the virtual experience application 112, respectively. In one implementation, the virtual experience application 112 may permit users to use and interact with online virtual experience server 102, such as control a virtual character in a virtual game hosted by online virtual experience server 102, or view or upload content, such as virtual experiences 106, images, video items, web pages, documents, and so forth. In one example, the virtual experience application may be a web application (e.g., an application that operates in conjunction with a web browser) that can access, retrieve, present, or navigate content (e.g., virtual character in a virtual environment, etc.) served by a web server. In another example, the virtual experience application may be a native application (e.g., a mobile application, app, or a gaming program) that is installed and executes local to user device 110 and allows users to interact with online virtual experience server 102. The virtual experience application may render, display, or present the content (e.g., a web page, a media viewer) to a user. In an implementation, the virtual experience application may also include an embedded media player (e.g., a Flash® player) that is embedded in a web page.

In some implementations, the virtual experience application may include an audio engine 116 that is installed on the user device, and which enables the playback of sounds on the user device.

According to aspects of the disclosure, the virtual experience application may be an online virtual experience server application for users to build, create, edit, upload content to the online virtual experience server 102 as well as interact with online virtual experience server 102 (e.g., participate in virtual experiences 106 hosted by online virtual experience server 102). As such, the virtual experience application may be provided to the user device(s) 110 by the online virtual experience server 102. In another example, the virtual experience application may be an application that is downloaded from a server.

In some implementations, each developer device 130 may include an instance of the virtual experience application 132, respectively. In one implementation, the virtual experience application 132 may permit a developer user(s) to use and interact with online virtual experience server 102, such as control a virtual character in a virtual game hosted by online virtual experience server 102, or view or upload content, such as virtual experiences 106, images, video items, web pages, documents, and so forth. In one example, the virtual experience application may be a web application (e.g., an application that operates in conjunction with a web browser) that can access, retrieve, present, or navigate content (e.g., virtual character in a virtual environment, etc.) served by a web server. In another example, the virtual experience application may be a native application (e.g., a mobile application, app, or a virtual experience program) that is installed and executes local to user device 130 and allows users to interact with online virtual experience server 102. The virtual experience application may render, display, or present the content (e.g., a web page, a media viewer) to a user. In an implementation, the virtual experience application may also include an embedded media player (e.g., a Flash® player) that is embedded in a web page.

According to aspects of the disclosure, the virtual experience application 132 may be an online virtual experience server application for users to build, create, edit, upload content to the online virtual experience server 102 as well as interact with online virtual experience server 102 (e.g., provide and/or play virtual experiences 106 hosted by online virtual experience server 102). As such, the virtual experience application may be provided to the user device(s) 130 by the online virtual experience server 102. In another example, the virtual experience application 132 may be an application that is downloaded from a server. Virtual experience application 132 may be configured to interact with online virtual experience server 102 and obtain access to user credentials, user currency, etc. for one or more virtual applications 106 developed, hosted, or provided by a virtual experience application developer.

In some implementations, a user may login to online virtual experience server 102 via the virtual experience application. The user may access a user account by providing user account information (e.g., username and password) where the user account is associated with one or more characters available to participate in one or more virtual experiences 106 of online virtual experience server 102. In some implementations, with appropriate credentials, a virtual experience application developer may obtain access to virtual experience application objects, such as in-platform currency (e.g., virtual currency), avatars, special powers, accessories, that are owned by or associated with other users.

In general, functions described in one implementation as being performed by the online virtual experience server 102 can also be performed by the user device(s) 110, or a server, in other implementations if appropriate. In addition, the functionality attributed to a particular component can be performed by different or multiple components operating together. The online virtual experience server 102 can also be accessed as a service provided to other systems or devices through appropriate application programming interfaces (APIs), and thus is not limited to use in websites.

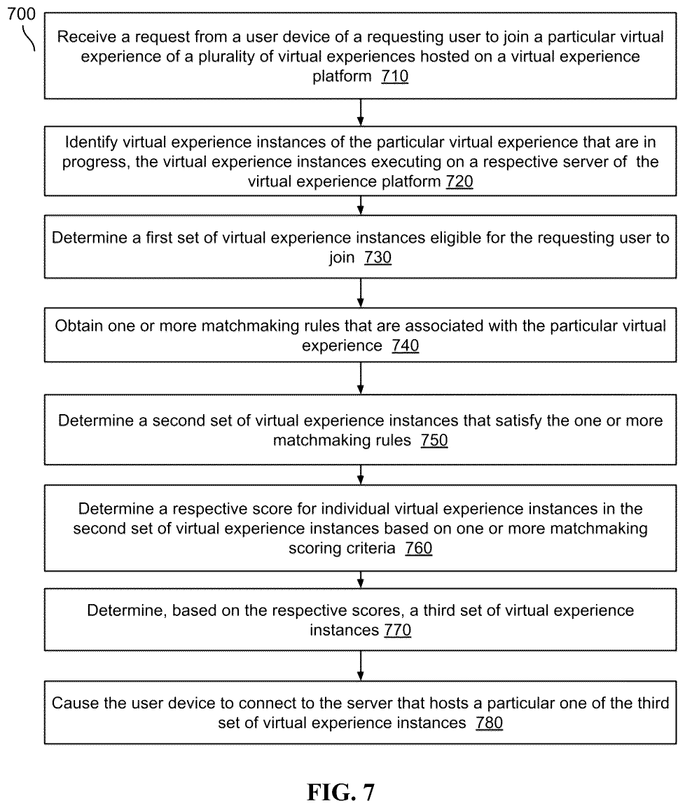

In some implementations, online virtual experience server 102 may include a graphics engine 108. In some implementations, the graphics engine 108 may be a system, application, or module that permits the online virtual experience server 102 to provide graphics and animation capability. In some implementations, the graphics engine 108, and/or matchmaking engine 140 may perform one or more of the operations described below in connection with the flowcharts and workflows shown in FIGS. 7, 8, and 9 and/or other operations described herein.

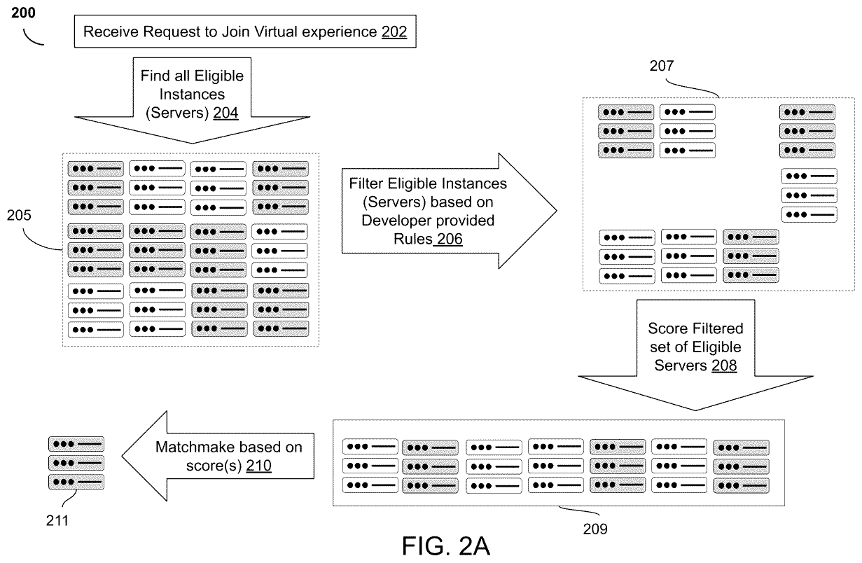

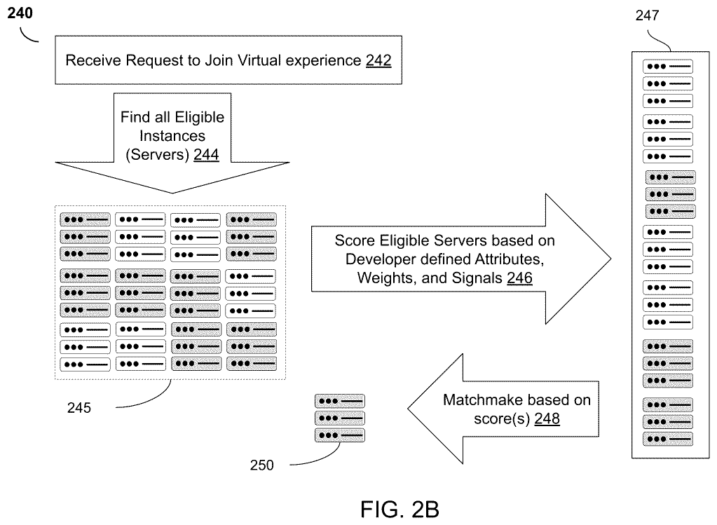

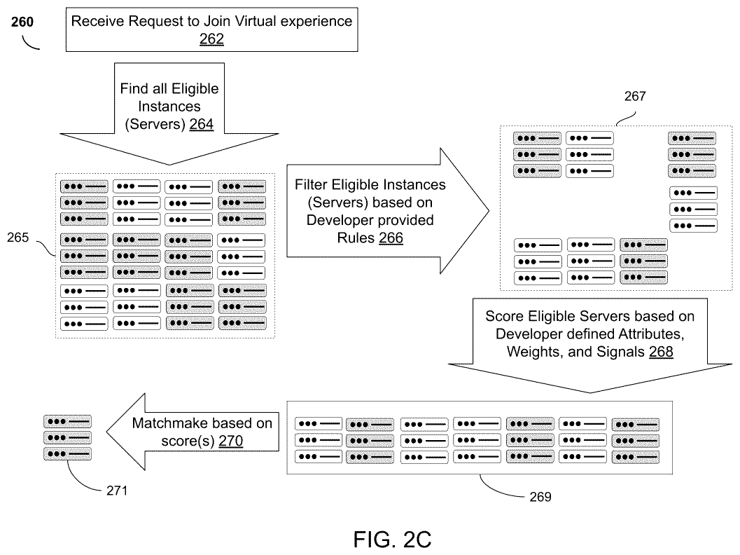

FIG. 2A is a diagram of an example method 200 to provide developer-customized matchmaking of players to virtual experiences, according to one or more implementations.

A player join request 202 is received by a matchmaking system (e.g., the matchmaking engine 140 and/or other component(s) of FIG. 1), which is a request for the player to join a particular virtual experience (e.g., by identifying a particular experience title, and/or experience type, version, etc.) that is run by a server of the virtual experience platform. For example, the join request can be a user selecting a play button, a join button, or inputting some other command to a user device (e.g., a client device) to join the particular virtual experience.

At block 204, the matchmaking system finds all active (currently executing) instances of the requested experience on the virtual experience platform that are eligible to be joined by the requesting player based on initial (strict) requirements. The system determines which eligible instances of the requested experience running on the platform are currently executing (e.g., potentially with one or more other players that are currently joined) and/or whether a new instance of the requested experience can be initiated on the platform.

In some implementations, the initial criteria of an instance to be eligible that are checked at block 204 can include that the instance is not full (e.g., has less than a maximum number of players currently joined), that the instance has a reserve status that allows the requesting user to join (e.g., it is not reserved for other users) (e.g., the reserved status allows particular players or groups of players to join the instance), and/or that routing rules are satisfied between the requesting player and the instance (e.g., to allow a minimum or otherwise sufficient level of network communication without latency, etc.). A first set of active, eligible instances 205 is determined at block 204.

At block 206, the first set of eligible instances 205 determined at block 204 is filtered for eligibility using developer eligibility rules. In this step/operation, the instances 205 from block 204 are filtered based on developer-defined eligibility rules and developer-defined attributes (e.g., player attributes and server attributes). These rules and attributes were selected (or originated, or defined) for use with the experience instances by the developer of the experience to provide custom matchmaking suitable for the developer's experience. Block 206 allows developers to customize matchmaking for their particular instances, by filtering out instances that are not eligible based on the developer eligibility rules. Some examples of developer eligibility rules are described elsewhere in this disclosure. A second set of active, eligible instances 207 is determined at block 206.

At block 208, the second set of eligible instances 207 determined from block 206 is scored for join suitability for the requesting user based on matchmaking scoring criteria (e.g., scoring algorithms). In some implementations, the matchmaking scoring can use a standard set of criteria and algorithms for all experience instances executing on the platform, so that consistency of matchmaking is achieved for all platform experiences. In some implementations, various characteristics (e.g., factors or signals) can be used to score of each eligible instance at block 208 such as, for example, characteristics related to the requesting user and the existing players already playing in an instance (e.g., a higher score based on the number of existing players being friends of the requesting user, having a close average age or age group to the requesting user, preferring the same language as the requesting user). Characteristics can include those related to determining whether the instance is connected to the requesting user with a reliable and fast network connection (e.g., the geographic distance between a server executing the instance and requesting user's device, or whether the instance server is located in the same country as the requesting user's device, the instance server is below a threshold latency to the requesting user's device, and/or the instance has a minimum occupancy (e.g., how many player slots are available in the instance for users to join, or how many users are currently connected to a game instance)). A score for each eligible instance 209 is determined at block 208.

At block 210, the scores of the eligible instances 209 determined at block 208 are compared and one of the eligible instances (e.g., a highest scoring instance 211) is selected, to which the requesting user device is automatically and seamlessly joined. In other implementations, a set of top scoring instances 209 can be presented to the requesting user, and the requesting user can select an instance from this set to join.

Thus, method 200 includes an intermediate block 206 between initial instance eligibility determination of block 204 and scoring of block 208. In this added stage, the instances are filtered based on developer-defined eligibility rules, allowing customization of matchmaking based on developer criteria.

FIG. 2B is a diagram of another example method 240 to provide developer-customized matchmaking of players to virtual experiences, according to one or more implementations.

A player join request 242 is received by a matchmaking system (e.g., the matchmaking engine 140 and/or other component(s) of FIG. 1), which is a request for the player to join a particular virtual experience (e.g., by identifying a particular experience title, and/or experience type, version, etc.) that is run by a server of the virtual experience platform. For example, the join request can be a user selecting a play button, a join button, or providing a command to a user device (e.g., a client device) to join the particular virtual experience.

At block 244, the matchmaking system finds all active (currently executing) instances of the requested experience on the virtual experience platform that are eligible to be joined by the requesting player based on initial (strict) criteria. The system determines which eligible instances of the requested experience running on the platform are currently executing (e.g., potentially with one or more other players that are currently joined) and/or whether a new instance of the requested experience can be initiated on the platform.

In some implementations, the initial criteria of an instance to be eligible that are checked at block 244 can include that the instance is not full (e.g., has less than a maximum number of players currently joined), that the instance has a reserve status that allows the requesting user to join (e.g., it is not reserved for other users) (e.g., the reserved status allows particular players or groups of players to join the instance), and/or that routing rules are satisfied between the requesting player and the instance (e.g., to allow a minimum or otherwise sufficient level of network communication without latency, etc.). A first set of active, eligible instances 245 is determined from block 244.

At block 246, the second set of eligible instances 245 determined from block 244 is scored for join suitability for the requesting user based on matchmaking scoring criteria (e.g., scoring algorithms). In some implementations, the matchmaking scoring criteria are specified by a developer of the virtual experience. In some other implementations, the matchmaking scoring criteria may be a combination of developer specified matchmaking scoring criteria and platform specified matchmaking scoring criteria. In some implementations, various characteristics (attributes, factors, and/or signals) can be used to score of each eligible instance at block 208 such as, for example, characteristics related to the requesting user and the existing players already playing in an instance (e.g., a higher score based on the number of existing players being friends of the requesting user, having a close average age or age group to the requesting user, preferring the same language as the requesting user). Characteristics can include those related to determining whether the instance is connected to the requesting user with a reliable and fast network connection (e.g., the geographic distance between a server executing the instance and requesting user's device, or whether the instance server is located in the same country as the requesting user's device, the instance server is below a threshold latency to the requesting user's device, and/or the instance has a minimum occupancy (e.g., how many player slots are available in the instance for users to join, or how many users are currently connected to a game instance)). A score for each eligible instance 247 is determined at block 246.

At block 248, the scores of the eligible instances 247 determined at block 246 are compared and one of the eligible instances (e.g., a highest scoring instance 250), may be selected, to which the requesting user device is automatically and seamlessly joined. In other implementations, a set of top scoring instances 250 can be presented to the requesting user, and the requesting user can select an instance from this set to join.

In some implementations, the virtual experience may be a game, and the attributes may include one or more attributes selected from the table below:

| Attribute | Type | Description |
|---|---|---|
| Estimated Player Latency | Numerical | The estimated latency of a player in a server. |
| Has Friends | Categorical | Whether a server has a connection or another |
| | | player of the same IP address as the joining |
| | | player. |
| Is Voice Chat Enabled | Categorical | Whether a player has voice chat enabled. |
| Player Age | Numerical | The player's age. |
| Player Device Type | Categorical | The player's device type. Can be a mobile device, |
| | | a computer, a tablet, a console, or a VR device, |
| | | etc. |
| Player Language | Categorical | The player's language. |
| Player Play History | Numerical | The log-10 of a number of minutes a player has |
| | | played in a universe in the past N (e.g., 28) days. |
| Server Occupancy | Numerical | The number of players in a server. |

In some implementations, the virtual experience may be a game, and signals may be determined based on the attributes. Examples are provided in the table below:

| Signal | Description |
|---|---|
| Age | The difference between the average age of players in the server and the joining |
| | player's age. In some implementations, a maximum relevant difference may be |
| | utilized. |
| Device Type | The ratio of players in the server with the same device type as the joining |
| | player. |
| Friends | The number of people in the server who are connected with the joining player |
| | or who share an IP address with the joining player. 1 if there is a preferred |
| | player, 0 otherwise. |
| Latency | The estimated player latency for a server, with a max relevant value. |
| Language | The ratio of players in the server with the same language as the joining player |
| Occupancy | The ratio of players in the server compared to the capacity of the server. |
| Play History | The difference between the average play history in the server and the joining |
| | player's play history, with a maximum relevant difference. |
| Voice Chat | The ratio of players in the server with voice chat enabled. |

In some implementations, custom signals may be utilized. Custom signals are created and defined by you and can be numerical or categorical. Numerical signals are numbers. They compare the difference between the joining player's attribute and the server's aggregated value, with larger differences lowering or increasing the score. For example, the closer the skill level of a player is to the average skill level of the server, the higher the numerical signal's score is. This score is then multiplied by the signal's weight.

Categorical signals are strings or booleans. They may be based on how common the joining player's attribute is when compared to the other players in the server. For example, if a high percentage of the players inside a server have the same preferred language as the joining player, the score increases. This score is then also multiplied by the signal's weight.

FIG. 2C is a diagram of another example method 260 to provide developer-customized matchmaking of players to virtual experiences, according to one or more implementations.

A player join request 262 is received by a matchmaking system (e.g., the matchmaking engine 140 and/or other component(s) of FIG. 1, which is a request for the player to join a particular virtual experience (e.g., by identifying a particular experience title, and/or experience type, version, etc.) that is run by a server of the virtual experience platform. For example, the join request can be a user selecting a play button, a join button, or inputting some other command to a user device (e.g., a client device) to join the particular virtual experience.

At block 264, the matchmaking system finds all active (currently executing) instances of the requested experience on the virtual experience platform that are eligible to be joined by the requesting player based on initial (strict) criteria. The system determines which eligible instances of the requested experience running on the platform are currently executing (e.g., potentially with one or more other players that are currently joined) and/or whether a new instance of the requested experience can be initiated on the platform.

In some implementations, the initial criteria of an instance to be eligible that are checked at block 264 can include that the instance is not full (e.g., has less than a maximum number of players currently joined), that the instance has a reserve status that allows the requesting user to join (e.g., it is not reserved for other users) (e.g., the reserved status allows only particular players or groups of players to join the instance), and/or that routing rules are satisfied between the requesting player and the instance (e.g., to allow a minimum or otherwise sufficient level of network communication without latency, etc.). A first set of active, eligible instances 265 is determined at block 264.

At block 266, the first set of eligible instances 265 determined at block 204 is filtered for eligibility using developer provided eligibility rules. In this stage, the instances 265 from block 264 are filtered based on developer-defined eligibility rules and developer-defined attributes (player attributes and server attributes). These rules and attributes were selected (or originated, or defined) for use with the experience instances by the developer of the experience to provide custom matchmaking suitable for the developer's experience. Block 266 allows developers to customize matchmaking for their particular instances, by filtering out instances that are not eligible based on the developer eligibility rules. Some examples of developer eligibility rules are described elsewhere in this disclosure. A second set of active, eligible instances 267 is determined at block 266.

At block 268, the second set of eligible instances 267 determined from block 266 is scored for join suitability for the requesting user based on matchmaking scoring criteria (e.g., scoring algorithms). In some implementations, the matchmaking scoring criteria is specified by a developer of the virtual experience. In some other implementations, the matchmaking scoring criteria may be a combination of developer specified matchmaking scoring criteria and platform specified matchmaking scoring criteria. In some implementations, in addition to developer provided criteria, the matchmaking scoring can use a standard set of criteria and algorithms for all experience instances executing on the platform, so that consistency of matchmaking is achieved for all platform experiences. In some implementations, various characteristics (factors or signals) can be used to score of each eligible instance at block 268 such as, for example, characteristics related to the requesting user and the existing players already playing in an instance (e.g., a higher score based on the number of existing players being friends of the requesting user, having a close average age or age group to the requesting user, preferring the same language as the requesting user). Characteristics can include those related to determining whether the instance is connected to the requesting user with a reliable and fast network connection (e.g., the geographic distance between a server executing the instance and requesting user's device, or whether the instance server is located in the same country as the requesting user's device, the instance server is below a threshold latency to the requesting user's device, and/or the instance has a minimum occupancy (e.g., how many player slots are available in the instance for users to join, or how many users are currently connected to a game instance)). A score for each eligible instance 269 is determined at block 268.

At block 270, the scores of the eligible instances 269 determined at block 268 are compared and one of the eligible instances (e.g., a highest scoring instance 271), is selected, to which the requesting user device is automatically and seamlessly joined. In other implementations, a set of top scoring instances 271 can be presented to the requesting user, and the requesting user can select an instance from this set to join.

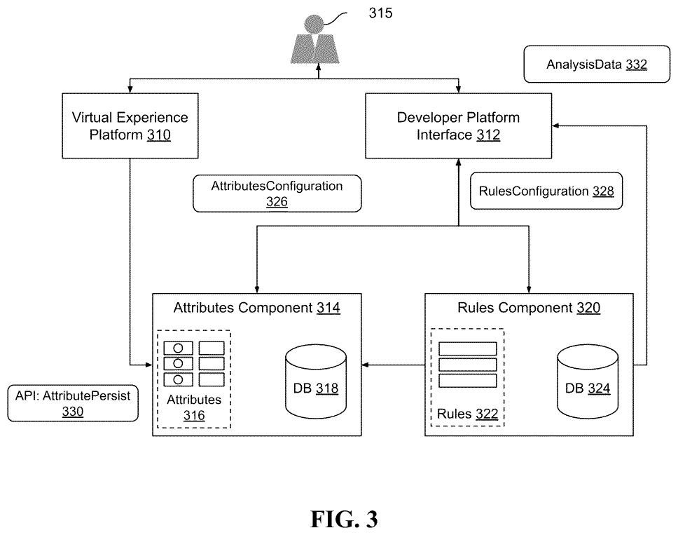

FIG. 3 is a diagram that depicts a system architecture of a customized matchmaking system from the perspective of a developer of virtual experiences on a virtual experience platform, in accordance with some implementations.

A developer user 315 (e.g., a developer who accesses virtual experience server 102 using a developer device 130) can interface with user interfaces (e.g., a user interface served via I/O interfaces 134) of the virtual experience platform 310 to create experiences on the platform. For example, a developer platform interface 312 can enable a developer to configure attributes and rules for the customized matchmaking system.

An attributes component 314 can store attribute configurations (e.g., the attributes 316 can be stored in an attributes database 318 of the attributes component 314). The attributes component stores and manages attributes 316 for the customized matchmaking system. In some implementations, the attributes component may be a computational process that creates, updates, and/or deletes an attribute for an experience; provides an application programming interface (API) for writing (storing) a value for an existing attribute for a player; and provides an API for reading (from storage) a value of an existing attribute for a player.

“AttributesConfiguration” 326 refers to the action of configuration of an attribute by a developer (e.g., via developer platform interface 312), and storing configuration information in attributes component 314. “AttributePersist” 330 refers to the action of updating the player attribute values to be persistent outside of an instance, and the update can occur during or at the end of the instance. For example, this may be done by developers using an API (e.g., a Lua API), at a particular frequency.

The attributes component 314 can be a separate block, or can be part of the customized matchmaking service, or can be split into different services (e.g., one service for use by a developer (e.g., via an API such as Lua) for writing, and another service used by other system services for reading). In some implementations, encryption as a service (EaaS) can be used to store the attribute configuration data, or other encryption format or process.

A rules component 320 can store rules configurations (e.g., the rules 322 can be stored in a rules database 324 of the rules component 320). The rules component stores and manages developer-defined rules. Each rule is an eligibility check on one or more developer defined attributes. Thus, the rules component is based on the attributes component (e.g., rules in the rules component 320 are evaluated based on one or more attributes obtained from the attributes component 314). In some implementations, these databases can be separate or part of a single database.

In some implementations, the rules component 320 is a computational process that creates, validates, updates, and/or archives a developer rule associated with a particular instance (e.g., is associated with a particular place in a particular instance); provides an API for getting a rulebook for matchmaking for a place; and integrates with an analysis component of the system to achieve negative rules detection (e.g., detection of when a rule finds an instance ineligible). In some implementations, encryption as a service (EaaS) can be used to store the rules data, or other encryption format or process.

In some implementations, the matchmaking system (e.g., the rules component 320) can also provide analysis data to the developer platform interface to be viewed by the developer user (e.g., statistics and other data indicating the number of users joining the developer's experiences on the platform over time), so that the developer can determine effects of customized matchmaking on the popularity and use of those experiences.

In some implementations, the developer can configure attributes and rules via other user interfaces and functions of the virtual experience platform. For example, after an attribute is configured, the developer can read/write attribute data to the attribute component via APIs accessible to the virtual experience platform, such as LuaAPIs and/or other APIs.

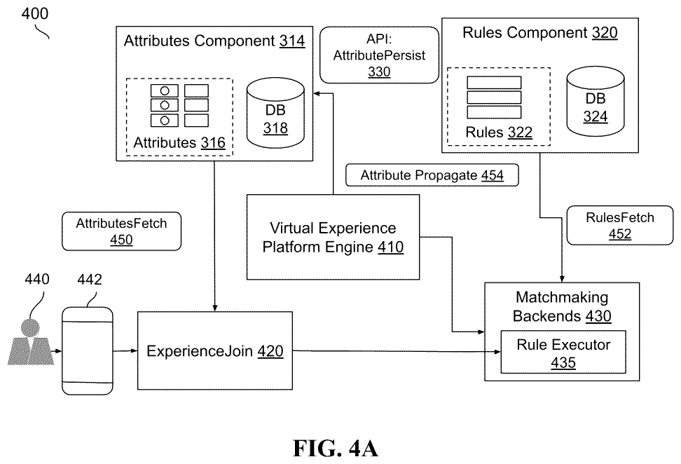

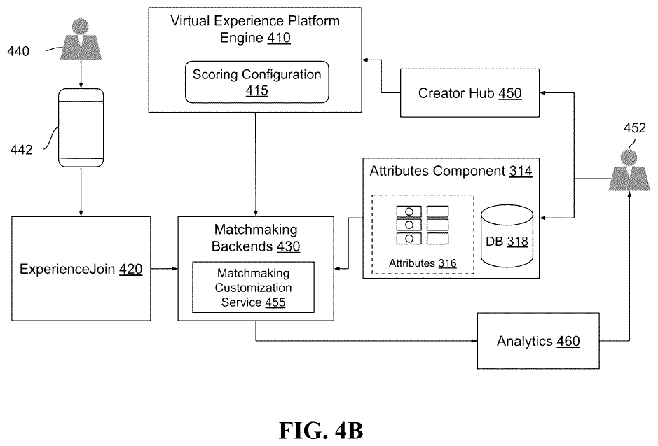

FIG. 4A is a diagram showing a system architecture of a customized matchmaking system from a perspective of a user that requests to join a virtual experience hosted on a virtual experience platform.

The requesting user 440 (“player” in FIG. 4A) can search for a desired experience on the virtual experience platform using a user device 442, such as a smartphone, tablet computer, desktop computer, or other client device. In some implementations, the requesting user can select a “play” button or join button associated with (e.g., displayed in connected with) a displayed title, label, or other identification of an experience (e.g., game or other virtual experience) they would like to join.

The identification of the user-selected experience is sent to a player join block or an experience join block 420 (ExperienceJoin). The experience join block 420 fetches attributes from the attributes component 314 that are associated with the selected experience, which the developer of the experience has previously defined. These attributes are sent by the player join block to the matchmaking backends block 430 (e.g., servers, such as server 102 in FIG. 1).

As described in implementations herein, player attributes are values that are directly associated with users (players), such as Elo rating, skill level, game mode preference, etc. They are defined by the developer for use with the virtual experience. Developers can also read/update the player attribute values during/after a session (e.g., a game session or a virtual experience session). Server attributes are values that are associated with a particular instance of the experience, such as ExperienceMode, GameMode, GameStage, etc. The server attribute's initial value is determined at the time when a new instance is to be created and that value may last throughout the instance lifecycle, from start to end of the instance (instance shutdown).

When a join request is received, player attributes of the requesting user are fetched (“AttributesFetch” 450) from the attributes component by the ExperienceJoin block 420 (and/or otherwise determined, e.g. based on user input selecting a play mode or other preference) and passed to matchmaking backends (to perform rule evaluations). Player attributes of the existing players in the instance can be fetched by the matchmaking backends from the platform engine (e.g., that is executing the instance). “AttributePersist” 330 refers to the action of updating the player attribute values to be persistent outside of an instance, and the update can occur during or at the end of the instance. For example, this may be done by developers using an API (e.g., a Lua API), at a particular frequency.

The matchmaking backends block 430 fetches the rules (e.g., using “RulesFetch” 452) from the rules component 320 that are associated with the selected virtual experience, which the developer of the experience has previously defined. In some implementations, each rule is also associated with a particular “place” of the experience (e.g., a place can be a zone, area, location, portion, scene, map, lobby, user interface, etc. in an experience, typically where players in the experience can meet and/or interact, and the experience typically includes multiple different places which (in some cases) can separate players from interaction if the players are not in the same place). For example, a starting place (e.g., root place) or lobby can be a default place in which a newly-joining player can join the experience, which can be a particular virtual environment, map, lobby, etc. In some implementations, places can be defined within other places, such that there is a hierarchy of places. In some implementations, a developer rule can apply only to a particular place, such that different places may have different rules applied. In the case of a player joining a starting place, the rules associated with that starting place are fetched from the rules component.

The matchmaking backends 430 block may receive information about currently active, eligible instances from the platform engine and/or the game join block. In some implementations, the matchmaking backends block 430 can perform an initial instance eligibility determination (e.g., block 204 of FIG. 2). A rule processor (rule executor 435) of the matchmaking backends block 430 can perform block 206 (e.g., evaluates active instances of the selected experience based on the rules obtained from the rules component, to determine a filtered set of instances). The matchmaking backends block 430 then scores the filtered set of instances (e.g., block 208) based on various characteristics of players and/or the server and instance (e.g., player age, language, etc., or server location and/or latency to the requesting user device, instance occupancy, etc.) and determines a highest scoring instance. The highest scoring instance can be provided to the player join block (or other component of the system) which causes the requesting user's device to join that instance.

In some implementations, the values for server attributes are set at the time of starting an instance. A server attribute's initial value (when an experience instance starts), can either be a constant or can be configured to be derived from a player attribute. If it is derived from a player attribute, the attribute value of the player that triggers the start of the instance can be used for the initial value of the server attribute.

In some implementations, once the instance starts, the platform engine block becomes the source of the valid (true) values of both player attributes and server attributes. This is because developers can choose to update those attribute values throughout the course of the experience instance. “AttributePropagate” 454 indicates that the updated attribute values are passed back from the platform engine block to the matchmaking backends block (e.g., at a particular interval, such a 30 second interval or other time period) so that the rule evaluator in the matchmaking backends has the most recent attribute values for evaluating rules for incoming new players. Thus, the platform engine (which can include the executing code of experiences) can propagate attributes to the matchmaking backends.

The data flow of a join request is described herein.

Form the Attribute Set for the Join Request: the attribute set for a join request represents the player attributes for the join (e.g., for the requesting user). In various implementations, a join request can be created via many different ways. The attribute set is formed for join requests that require matchmaking (e.g., play button, teleport, etc.).

The developer can pass in attributes overrides via “teleport.” A teleport occurs when an experience (e.g., based on developer code) moves one or more players to a place within the virtual experience. In some cases, if the moved players were previously in a different place, this can cause a different set of rules to apply to those players that have moved. For example, a different set of attributes can be provided to players that have teleported. When a join request arrives at the experience join block (e.g., via a GameJoin API), any attribute overrides are merged with the fetched attributes from the attribute component, and the merged attribute set is propagated to the matchmaking backends (e.g., matchmaking and/or system components that maintain states of executing experiences on the virtual experience platform).

Get the Attribute Set for the Experience Instance: The attribute set for an instance represents the player attributes for players already in that experience instance and also the server attribute of the instance. In some implementations, this data may come from the platform engine (e.g., after a refresh of the platform engine) and can be stored together with the experience object (data defining the experience) in memory.

Fetch RuleBook for the Place: When a join request is received, the RuleBook is fetched for the place of the requested experience (e.g., a starting place as default), and the RuleBook is sent to the rule executor for evaluation.

Propagate Player Attributes to platform engine: After an instance is selected as the matchmade instance to be joined, the player attributes are propagated to the platform engine that executes virtual experience instances (e.g., via the JoinScript).

Propagate Server Attributes to platform engine via GameStartMetadata on Dispatch: The server attribute of an instance is determined when the experience instance is started (dispatched). All server attributes for the experience are fetched and combined with the attribute set in the join request to determine the server attributes for this instance, which are propagated to the virtual experience platform engine 410. For a prewarmed instance (e.g., an instance that has been previously allocated in memory and/or initiated to speed startup), instead of a game start dispatch, the virtual experience platform engine 410 is notified and this notification includes the server attributes.

Refresh update Attribute Set on instance: Once an instance starts, the platform engine holds the source of truth for the player attributes and server attributes within the instance. The developer game code can update server attributes and player attributes as the instance executes, and the updated attribute set gets sent back from the platform engine to the matchmaking and instance service via a refresh of the platform engine.

FIG. 4B is a diagram that depicts another system architecture of a customized matchmaking system.

The requesting user 440 (“player” in FIG. 4B) can search for a desired experience on the virtual experience platform using a user device 442, such as a smartphone, tablet computer, desktop computer, or other client device. In some implementations, the requesting user can select a “play” button or join button associated with (e.g., displayed in connected with) a displayed title, label, or other identification of an experience (e.g., game or other virtual experience) they would like to join.

The identification of the user-selected experience is sent to a player join block or an experience join block 420 (ExperienceJoin). A matchmaking backends block 430 that includes a matchmaking customization service 455 obtains a scoring configuration 415 for the identified virtual experience from virtual experience platform engine 410 as well as attributes 316 for the particular virtual experience from attributes component 314.

Scoring criteria for the virtual experience is previously provided by developer (developer user) 452 via a creator hub 450. The scoring criteria may include signals, attributes, weights, etc., specified by the developer and stored in attributes component 314 (e.g., on database 318).

Analytics 460 may be generated by the matchmaking backends 430 and provided to the developer 452.

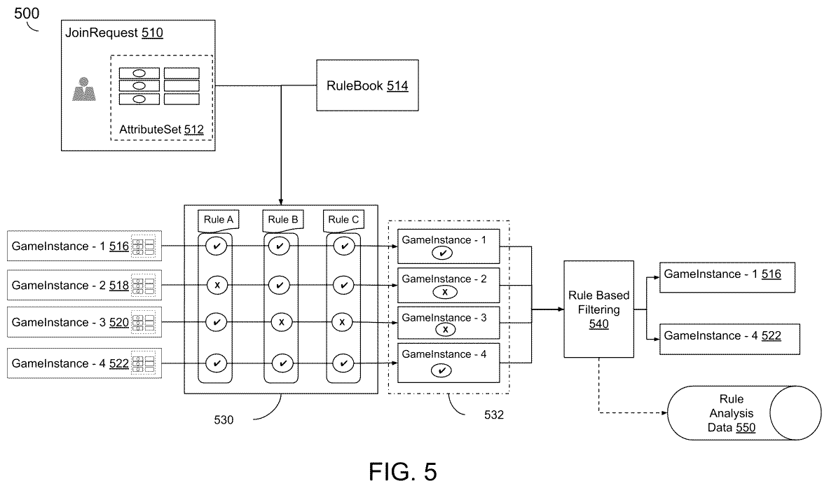

FIG. 5 is a diagram of an example method to provide evaluation and filtering of eligible game instances based on developer-defined rules, according to one or more implementations.

In some implementations, evaluation and filtering of eligible game instances according to developer rules can be performed by a rule executor (e.g., similar to rule executor 435 described with reference to FIG. 4A). The rule executor may be a piece of code that controls the core logics of the rule evaluation and execution. For example, the rule executor can be included in a matchmaking backends similarly as described for FIG. 4A.

In some implementations, the rule executor takes in the following three types of data, and outputs a list of eligible game instances that meet the eligibility requirement of the developer rules. The three pieces of data include: an attribute set 512 associated with the join request from the requesting user; attribute sets (516, 518, 520, and 522) of a list of eligible experience instances; and a “rulebook” 514 that includes one or more rules.

The first stage is rules evaluation 530. In this stage, every experience instance is evaluated by all the rules in the rulebook and a rulebook evaluation is performed for each rule and a rulebook evaluation result 532 is generated which is the summary of all the rules results. The second stage is rule based filtering 540. In this stage, the overall results of all experience instances are evaluated and a decision is made as to the instances to pass to the next scoring step; this stage also can output analysis metrics 550 asynchronously.

For example, a rule evaluation block 530 receives the attribute set associated with the join request 510, where that attribute set includes the player attributes associated with the requesting user. The rule evaluation block also receives the set of attributes for each eligible instance of executing experiences, which can include player attributes of existing players connected to each eligible instance, and server attributes of each eligible instance. In some implementations, the eligible instances may have been previously initially filtered for eligibility as described above for stage 204 of FIG. 2. The set of attributes for each of these instances can be obtained from the attributes components. The rule evaluation block also receives the rulebook that includes the developer rules associated with the experience to be joined (and/or associated with a particular place to be joined or moved to within that experience).

The rule evaluation block 530 evaluates received player attributes based on each rule in the rulebook and provides a rule result for each attribute. The rule result indicates whether the instance has been determined to be eligible or ineligible for the join request based on that rule. The rule evaluation block also outputs a rulebook evaluation result for each instance that summarizes the results of all the rules for that instance. For example, if the rule results for one or more rules in the rulebook found that the instance is ineligible, the overall rulebook result indicates that that instance is ineligible; if all rules in the rulebook found that the instance is eligible, the overall rulebook result indicates that that instance is eligible.

The result of each rule evaluation is sent to the rule based filtering block 540 that evaluates the rulebook results and outputs the instances that have rulebook results indicating the instance is eligible (e.g., all rule results of all rules in a rulebook indicate eligibility). In this example, the rule based filtering block 540 outputs game instances 1 and 4 as eligible based on the rule results, while game instances 2 and 3 are ineligible and are not output.

In some implementations, the rule based filtering block 540 can also output rule analysis metrics 550 and other data that can be used to display statistics indicating which instances have been found eligible via developer rules, as described elsewhere herein. In some implementations, an analysis component can transform the analysis metrics into an aggregated dashboard to be available to display in the developer interface for developers. In some implementations, the analysis component can provide real-time data analysis support so that developers can evaluate effects of launching new rules. The analysis component can integrate with the rules component to achieve negative rule detection (e.g., detection of rules causing players to not join an instance).

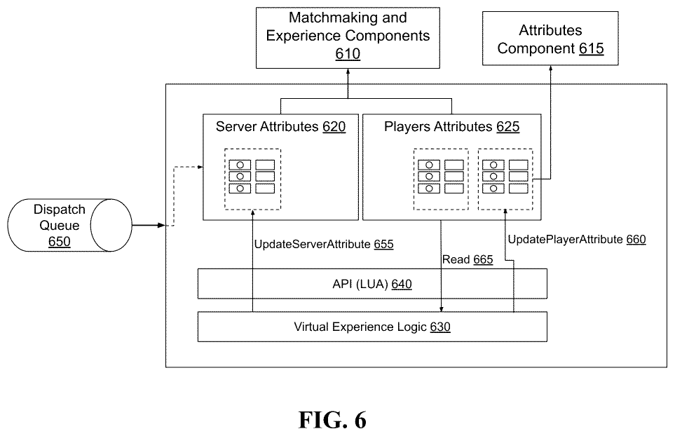

FIG. 6 is a block diagram of an example platform engine that maintains server attributes and player attributes data in memory.

The platform engine (e.g., the matchmaking engine 140 and/or other component(s) of FIG. 1) executes various experiences for the virtual experience platform. An experience (e.g., game logics stored as virtual experience logic 630) executing in the platform engine can read/write server attribute data and player attribute data (e.g., by using Read 665) in the platform engine via an API such as LuaAPI 640.

Upon refresh of the platform engine, the attributes set data are propagated to the platform engine or component(s) (e.g., matchmaking and experience components 610 and attributes component 614). Player attributes may also be propagated to the attributes component 615 for persistence.

### Customized Matchmaking System—Additional Example Implementations

In some implementations, the customized matchmaking system allows developers to use two sets of attributes: player attributes 625 and server attributes 630. Using these two attribute types, creators can define rules that constrain what instances are eligible for what players. Both player and server attributes, as well as the rules defined below, may provide a set of controls that allow developers to provide solutions for any of the use cases identified herein.

Some examples of use cases for customized matchmaking include: skill-based matchmaking (match players that have a similar level of skill, experience, Elo score (ELO is a common rating system to measure player skill), etc. for a particular game/experience); play modes (match players that desire to play the same type of mode of an experience, e.g., casual, ranked or competitive, cooperative, solo, duo, four player, etc.); latency-sensitive games (match players that have similar latencies for experiences that are designed for lower latencies, such as fast-paced real-time games); round-based games (e.g., allow players to immediately or quickly join a round-based game to eliminate or reduce waiting in a queue); etc.

These rules impact whether an experience instance is eligible for players. A matchmaking scoring algorithm can then choose the best instance among these eligible instances. When the rules result in no instances being eligible, matchmaking considers an expanded criteria set for each rule defined by the developer, followed by setting optional rules if no instances continue to exist.

### Feature Building Blocks

Developer customized matchmaking can be broken down into a set of building blocks or customization primitives that work together: attributes that include player attributes and server attributes; rules system; queue system; latency tolerance; and latency improvements.

An attribute is a developer-defined strongly typed piece of data that is associated with players or experience instances. Attributes are defined at the experience level. Attribute data will be evaluated against by rules during the matchmaking process. There are two different types of attributes: player attribute 625 and server attribute 629.

The customization system allows developers to create two sets of attributes: player attributes and server attributes. Using these two attribute types, developers can define rules that constrain which instances are eligible for which players. By defining rules with both player attributes and server attributes as inputs, a full set of controls is provided that allow developers to align their experience with any of the use cases identified herein.

Player attributes: Developers can define player attributes. A player attribute is directly associated with a player. These attributes can include, for example, ELO, skill level, game mode preference, etc., and support use cases such as skill-based matchmaking and play modes. These attributes can be used by the rules system and queue system building blocks.

Player attributes are defined before they are set. In some implementations, the set of player attributes are defined at the experience level and shared by all places within the experience (in other implementations, player attributes can be defined at a place level or other level in the platform). In some implementations, developers can define up to N player attributes per experience (e.g., 5). In some examples, the player attribute definition can include attribute name, type, and default value (e.g., a constant). In some implementations, player attributes are persistent, e.g., stored persistently in data storage of the platform.

In some implementations, there are two ways developers can set player attributes: an API (e.g., Lua API 640) and teleport. For the API, developers can persistently set the attribute for a player via an API call for the platform. In some implementations, the new value does not take effect until the next join. For the teleport, developers can specify attribute values for a single join. These will take precedence over attributes set via the API, but they are not persistent. If specified, this value will be used for an entire play session of an instance. After a new player attribute is created for an experience, all players have the default value until an instance of that experience sets a different value for a player.

Developers can use player attributes in a variety of ways; some examples follow.

In skill-based matchmaking using bucketing, the developer can create a “rank” string attribute that can be used to group players in predetermined buckets based on their rank. For example, a default value can be “bronze” rank. As players improve, the developer can set the rank to “silver,” “gold,” etc. Developers can utilize this attribute with a rule that players must have an equal “rank” attribute to be grouped in the same instance.

In skill-based matchmaking using grouping, the developer can create a skill value attribute, such as an “Elo” integer attribute, with a default value (e.g., 1500 or other defined value). As players win or lose matches, the developer sets the skill value accordingly. Developers can utilize this attribute with a rule that players have a max difference (MaxDiff) of M between their skill value attributes to be grouped in the same instance (e.g., a maximum difference of 200 between Elo attributes). Developers can use a skill value attribute defined by the platform, or may define their own custom skill rating values (e.g., numerical ratings) for use in grouping or bucketing, where the skill rating values can be based on one or more particular player or experience characteristics. For example, a developer can create a custom skill rating value that is based on number of player victories, number of player “kills,” number of player defeats or deaths, number of victories or defeats within particular time periods, and/or other characteristics related to player performance in the experience.

Player attributes may be persistently stored on the virtual experience platform. For example, a rank or skill rating can be persistently stored in association with a particular player and in association with the particular experience to which it applies. For example, when an instance is shut down, persistent player attributes can be propagated to other components of the platform for storage, such as the attribute component, where they can be stored in association with identifications of the player and the experience.

In a play mode example, a developer can create a “PlayMode” string attribute with a default value of “default.” The attribute is overwritten with a player-requested mode (e.g. “duos” (2 players), “quads” (4 players), “role-play” (no scoring or winning/losing), “serious,” “casual,” etc.). Developers can utilize this attribute with a rule that players must have an equal “PlayMode” attribute to be grouped in the same instance. This causes separation of players into their desired play modes. Since attributes are persistent, players will be able to instantly join an instance with the desired “PlayMode” from the play button whenever they rejoin an instance of the same experience.

In some examples, a player preference for play mode can be obtained by the system when the player selects from multiple offered modes of the virtual experience (e.g., in a menu, lobby, or other options displayed to the player prior to or upon joining). The player selection of preferred play mode can be written into the play mode player attribute for that player. This player attribute can be updated to a different play mode if the player selects that different mode for that experience. In some implementations, the player can provide a preferred play mode in response to prompts from a requested experience or from the platform.

Similarly to the skill-based player attributes, play mode player attributes are persistently stored by the platform in association with the player and with the experience, so that when the player next joins that experience, the pertinent play mode attributes are retrieved, and the player is routed to join an instant having the player's preferred play mode as indicated in the attribute.

Server Attributes: These also can be referred to as “instance attributes.” A server attribute is associated with an experience instance. Developers can define custom attributes per experience instance. Examples of server attributes include play mode (e.g., experience mode or game mode), game stage, etc., which indicate that the specified mode or stage is supported by that instance; other server attributes can include the current player count within that instance (number of existing players connected to that instance), which is updated as new players join the instance. Server attributes can support use cases such as skill-based matchmaking, play modes, and continuous round-based games. These attributes are used by the rules system and queue system building blocks.

Server attributes are defined before they are set. Server attributes are defined at the experience instance level and, in some implementations, are shared by all places within the instance. In some implementations, developers can define up to N server attributes per instance (e.g., 5). The server attribute definition includes attribute name, type, and default value. Developers can call an API (e.g., Lua API) to set server attributes for an instance at any time. For example, with APIs, developers can read different server attribute values to render different objects in an instance, and/or they can change a server attribute's value as the instance executes. Server attributes are not persistent-they are tied to the specific instance and are no longer relevant once the instance shuts down. In some implementations, a server attribute's initial value is determined at the time when a new instance needs to be created, and the data in the server attribute lasts during the whole lifecycle of the instance, from start to end (instance shutdown). For example, a server attribute's initial value (when an instance starts), can be configured to be a constant or configured to be derived from a player attribute. If it is from a player attribute, the attribute value of the player that triggers the game start will be used for the initial value of the server attribute. In some implementations, server attributes for a join can be specified during a teleport of players to a place in an experience instance.

In some implementations, there are two contexts in which server attributes are set: for a join and for the instance. For a join, the desired server attributes are used for every individual join attempt. (For teleports, developers can specify which server attribute values to use. For non-teleports, the default values can be used.) For example, developers can set attribute values for the current instance, e.g., via an API (e.g., Lua API), e.g., at any time. If a join creates a new instance, the values that were used for the join will be the values set for the new instance on startup.

Developers can use server attributes in a variety of ways; some examples follow.

In continuous round-based games, the developer can create a “JoinEnabled” boolean attribute with a default value of “true.” When a round is in progress, set this to “false” and then back to “true” when the round is complete. Developers can create a rule that allows a player to only join instances with “JoinEnabled” set to “true.”

In skill-based matchmaking using bucketing, the developer can create a “rank” string attribute with “bronze,” “silver,” etc. ranks (as above). When a player wants to play a ranked game, the developer can initiate a teleport that passes in the appropriate “rank” attribute to the game instance (e.g., based on the rank of the existing players in the game instance). The developer can create a rule that matches players based on the “rank” attribute. Skill-based matchmaking using grouping can use similar techniques.

Rules System: A matchmaking rule is a developer defined eligibility criteria of whether a player (or a group of players) can be matchmade to an instance. Developers can define eligibility using attributes and a set of rules. In some implementations, the rules can be platform-provided logic blocks 630.

The rules system supports use cases such as skill-based matchmaking, play modes, continuous round-based games, one-shot round-based games, etc. Rules allow a developer to customize eligibility of experience instances to player join requests. Rules impact whether an instance is eligible for players. In some examples, a set of rules can be grouped into a “rulebook”.

Rules indicate which players are eligible to play together and which instances this player is eligible to join. In some implementations, rules receive input data and return a true/false result for eligibility. During matchmaking, a rule takes the requesting player {player attributes} and the {server attributes+players attributes} of the instance and performs an evaluation. When the result is true, the player can join this instance; otherwise, they cannot. Input data to a rule includes player attributes, server attributes, and, in some cases, one or more constants defined in the rule itself. In some implementations, all pieces of input data are the same type. In some implementations, up to N rules can be defined (e.g., 5) by the developer in a rulebook. Rule results are combined together (e.g., via an AND operation). In some implementations, a single attribute cannot be used in multiple rules within a single place. By default, a rule is a soft requirement.

In some implementations, rules are configured per place within an instance, so that each place may have its own associated rulebook. This allows different places within an experience to have different matchmaking rules. For example, the developer might want different types of rules to apply for players wanting to join a particular place of an instance. For example, there can be a lobby place where developers allow all different kinds of players to join, and there can be other places in the experience for specific matches or competitions in which the developer may want to restrict participating players in the matches to players having similar skill levels, or may not want a greater number of people to join that place until a round is complete, etc.

Hard rule, soft rule: a boolean field in each rule can be used to control whether a rule is hard or soft. This determines the outcome if no instances are eligible due to rules filtering. For example, if there is only one rule in the RuleBook: For a soft (optional) rule, the rule is ignored, and ineligible game instances are considered as eligible. For a hard (required) rule, the rules must be complied with, and a new instance is started for the requesting player to join. For a multiple rules scenario, all instances are scanned first with all rules, and if no instances are eligible, they are scanned again with only the required rules. If still no instances are eligible, a new instance is started.

Rule expansion, hard requirements: Often, a rulebook will be evaluated and the rules cause all eligible instances to be filtered out for the joining player. Or, in the case of a queue-based join, not enough players from the candidate pool are eligible to play together to form a match. Developers can use system tools to decide what happens in these cases. For example, rule expansion allows a developer to expand the criteria for a rule, and hard requirements allows a developer to specify that a new instance must be created if the rule cannot be satisfied.

In the case of instant matchmaking, the rulebook is evaluated in three contexts. New instances are created only if no eligible instances can be found under all three contexts. These contexts are 1) Use the non-expanded rule definitions to find matches, where every rule has a hard requirement; 2) Use the expanded rule definitions to find matches, where every rule has a hard requirement; and 3) Use the expanded rule definitions to find matches, where rules have soft requirements unless explicitly marked as having hard requirements.

In the case of queue-based matchmaking, the non-expanded rule definitions can be expanded to the expanded rule definitions as players wait in the queue. See the queue system for more details below.

The definition for “non-expanded” and “expanded” rules can be defined per rule type. For example, the max difference rule can expose an initial threshold and an expanded threshold. Rule expansion may not be supported for all rules, as some rules may not have any meaningful way to be expanded. If a rule supports an expanded version, the expanded version is to be defined (the same definition as the non-expanded rule can be used). In some implementations, all rules are expanded in unison; or in other implementations, one rule can be expanded first, and if that fails then two particular rules can be expanded, etc.

Default behaviors on absence of an attribute: Although attributes are defined before a rule can be created on an attribute, it may still be possible in some implementations for an attribute to be absent when trying to apply a rule. For example, an instance can be a long-lasting one that exists even before the time the server attribute is created. Thus, when an attribute is missing, the default value of attribute can be used.

Unreachable instances: Unreachable instances may exist if rules can be “required”. (If rules are always optional, this may not be applicable.) Unreachable instance due to outlier joins: An exact match rule built on a player attribute involves all players in the target instance having the same value for the attribute. If a single player is able to join an instance with a mismatched attribute value, it is impossible for the exact match rule to return true from that point on.

Example cases where this may occur: 1) A player's attribute value is updated (e.g., by using UpdatePlayerAttribute 660) after joining an instance and no longer matches the value of other players. Mitigation option: If attribute values are updated, they do not take effect until the player joins a new instance. 2) A player does a direct join to an instance (instance browser, game invite, play with user, etc.). Mitigation options: in some implementations, joins are not allowed if the rules aren't matched, even on direct joins; or, allow joins and developers cannot use non-root places with the direct join toggle disabled. 3) In a rule expansion system or soft requirement system, a join using those could cause a mismatch with the base rules. Mitigation option: rule expansion/soft requirements can be disallowed on rules for instant joins.

In some implementations, rule conditionality can be implemented by the platform to allow additional flexibility to matchmaking for developers. For example, the developer can specify one or more conditions that may trigger a rule to be applied for an instance (or a place). The conditions can be, for example, particular numbers of players in an instance (or place), particular frequency or timing of joins to an instance (or place), a threshold number of players with a particular player attribute being in an instance, etc.

Example Rule Types: Example predefined rules that can be provided by the platform to developers can include:

Exact match rule (equality rule): Returns true if two pieces of data match in their values (including numeric values, text strings, etc.).

Max difference rule: The MaxDiff rule limits the maximum difference of player attributes within an instance. Returns true if two pieces of data have an absolute difference in their values, within a threshold.

Latency tolerance rule: Returns true if latency is tolerable according to the specified value. See section “Latency Tolerance” below.

Instance occupancy rule: Returns true if instance occupancy (number of connected players) is at least a threshold number or percentage of full occupancy. In some implementations, this may only be valid for queue-based joins.

Exact match rule constraints: In some implementations, the following constraints can be used to the above exact match rule to reduce the possibility of a player's join request creating an instance that the same player cannot join: 1) The right side of the equality is a server attribute, and the left side can either be a constant value or a player attribute. 2) For hard rule, if the server attribute has a constant default value, then the left side is a constant value which is the same as the default value. 3) For hard rule, if the server attribute has a default value derived from a payer attribute, then the left side is exactly the same player attribute that infers the server attribute.

MaxDiff rule constraints: In some cases, the MaxDiff rule can be considered to be the formula: abs (X−Y)<MaxDiffThreshold. The following constraints can be used: X is a player attribute, and Y can either be an aggregation of the player attributes of existing players, or a server attribute of the same data type. The MaxDiff threshold must be larger than 0.

### Rule Implementation Examples:

Exact match rule (or equality rule): Evaluate the equality of a player attribute from a matchmaking request (or a constant) against a server attribute of an instance. Logic: A==B, where A is joining player attribute or constant, B is candidate server attribute. Rule expansion is not applicable. Example 1—“bronze/silver/gold” instances: create rule with A set to Player.Rank, B set to Instance.Rank. Developer sets Player. Rank via Lua API. Example 2—Stop Join: Create rule with A set to constant true, B set to Instance.JoinsAllowed. Developer sets Instance.JoinsAllowed to enable/disable joins to the instance.

Max difference rule: Returns true if the largest absolute difference between all pieces of data is within a threshold. Logic: max (abs (A−B))<=T, where A is Joining player attribute or constant, B is candidate server attribute or candidate player attribute (if player attribute, take the max absolute difference across all players), and T is a constant, the threshold to use. Rule expansion: A new T where T2>=T1. Example 1—Skill similarity: instances where all players have similar skill level; create rule with A set to Player.ELO, B set to Player.ELO, T set to 200. Example 2—Level progression similarity: instances where all players have similar level progression; Create rule with A set to Player.Level, B set to Player.Level, T set to 10. Example 3—Level range instances: instances that have players level 0-10, 10-20, etc.; create rule with A set to Player.Level, B set to Instance.LevelRange, T set to 5.

Latency tolerance rule: Returns true if latency is acceptable (e.g., within a predetermined threshold or a dynamically-determined threshold). See dedicated section below for latency tolerance.

Instance occupancy rule: Returns true if the number of players in the instance will be greater than a threshold after the join. Developers can specify a multiple for team-based games. Logic: occupancy>=T && occupancy % M==0, where occupancy is an internal attribute, the number of players that would be in the instance after the match is created; T is a constant, threshold for the minimum number of player (is <=Max Occupancy for the place); M is a constant, a multiple to guarantee that a match will have an equal number of players per team. Rule expansion: A new T and M where T2<=T1, M2<=M1. Note: This rule is ignored if the place has instant matchmaking configured (see queue system). Example 1: a Team-based game that needs at least 4 vs 4 players to start a match; Create rule with T set to 8, M set to 2.

Range rule: Returns true if the input is within the specified range. This may be useful if the range can be dynamically set on join.

Bucket rule: Returns true if the input attribute is in the same bucket as the candidate. The developer can define up to N buckets (e.g., N is 5) which cover-infinity to +infinity.

Set intersection rule: If support set types, returns true if there are any common elements between all the sets.

Any match rule: Returns true if any subset of the input attribute exists in the target attribute. Example: Player. Rank with “bronze” would match if any player in the target instance had rank “bronze.” Note: If set types are supported, this can use the same logic as set intersection rule but involves a single player to match.

Difference from aggregate rule: Same as max difference rule, but it takes an aggregate function to apply to the player attribute (e.g. average, minimum, mode, etc.).

Relative difference rule: Returns true if the absolute difference between two pieces of data is within a threshold percentage.

Further Example Rules with Attributes Setups: This section lists some example use cases with setups of rule+attributes+API. Note, “GameMode” represents a server attribute that never changes, and “GameState” represents a server attribute that can be changed during the game play.

Stop matchmaking for an instance:

ServerAttribute {
Name: “Joinable”,
Type: “Boolean”,
Default: true
}
Rule {
Type: “Equality”,
LeftAttribute: Constant.“true”,
RightAttribute: Instance.“Joinable”
}

Effect: After setting an instance's attribute “Joinable”=false, then no player will be able to join.

Different game modes from teleport:

ServerAttribute {
Name: “GameMode”,
Type: “String”,
Default: “Unranked”
}
Rule {
Type: “Equality”,
LeftAttribute: Instance.“GameMode”,
RightAttribute: Instance.“GameMode”
}

Teleport API examples:

JoinRequest {
Attributes: {
InstanceAttribute {
“GameMode”: “Ranked”
}
}
}

Effect: Developers teleport players with different GameMode and matchmaking will happen per game mode.

Different ranked instances from play button:

PlayerAttribute {
Name: “Rank”,
Type: “String”,
Default: “Bronze”
}
ServerAttribute {
Name: “Rank”,
Type: “String”,
Default: Player.“Rank”
}
Rule {
Type: “Equality”,
LeftAttribute: Player.“Rank”,
RightAttribute: Instance.“Rank”
}

(This rule can also be just matching player attributes.) Effect: Players joining from selection of a play button (join command) will join instances the same as their rank, and a new instance's rank will be the same as the player that triggers the game start.

ELO based max diff matchmaking:

PlayerAttribute {
Name: “ELO”,
Type: “Integer”,
Default: 50
}
Rule {
Type: “MaxDiff”,
LeftAttribute: Player.“ELO”,
RightAttribute: Player.“ELO”
MaxDifference: 10
}

API examples: Developers call Player.SetAttribute(“ELO”, X) to persist players' attributes. Effect: Players joining will do ELO based matchmaking not exceeding MaxDiff of 10.

Continuously leveled up players and instances:

PlayerAttribute {
Name: “Level”,
Type: “Integer”,
Default: 1
}
ServerAttribute {
Name: “Level”,
Type: “Integer”,
Default: Player.“Level”
}
Rule {
Type: “MaxDiff”,
LeftAttribute: Player.“Level”,
RightAttribute: Instance.“Level”
MaxDifference: 5
}

API examples: As a game goes on, both players and instance objects (e.g., enemies or obstacles) may increase in levels or rating. Developers call Player.SetAttribute (“Level”, X+1), and Instance.SetAttribute (“Level”, X+1) to update the states. Effect: Players joining the ongoing games will not be too different in their levels.

Game backfillings: This is an example of optional Equality rule with server attribute derived from player attribute.

PlayerAttribute {
Name: “PreferredRole”,
Type: “String”,
Default: “DPS”
}
ServerAttribute {
Name: “RequiredRole”
Type: “String”
Default: “”
}
Rule {
Type: “BackfillingRule”,
LeftAttribute: Player.“PreferredRole”,
RightAttribute: Instance.“RequiredRole”
Optional: true
}

API examples: As the game is going on (filling up with players), the game can update (e.g. by using UpdateServerAttribute 655) its server attribute {“RequiredRole”} to find proper players to join the game in roles required by the game. Effect: Players will be more likely to join a game that requires a role matchmaking with their preferred role.

Queue system: Developers can create a new instance with a guaranteed number of players. A dispatch queue 650 may be utilized to store a list of prospective participants in a virtual experience. Supports use cases including one-shot round-based games, skill-based matchmaking, latency-sensitive games, and continuous round-based games. Queue-based matchmaking is different from instant matchmaking that evaluates a joining player against a list of existing running instances. Queue-based matchmaking evaluates players against each other, with the goal of creating a new instance with a requisite number of players.

In some implementations, developers can have a toggle which allows them to switch between “instant matchmaking” and “queue-based matchmaking” per place in an experience. The rules system is compatible with both types—the developer does not need to update their rules when switching matchmaking types. In some implementations, queue-based matchmaking is not enabled on the root place (so that selecting the play button by the requesting user always provides an instant join).

When a player initiates a join they can be entered into a player pool. The virtual experience platform searches the pool for groups of players that satisfy all rules. Once it finds a large enough group it creates a new instance and reserves a slot for all players there. In some implementations, by default, the platform can search for a group that matches the place's maximum occupancy, but this behavior can be developer-customized with an instance occupancy rule.

Search expansion: The longer a player waits in the queue, the more desirable it becomes to expand the rules for that player's join, to allow the player to quickly join an instance. Expanding rules increases eligibility for different players to play together and ensures everyone can find a match. In some implementations, the following phases can be used while a player is waiting in the queue:

Phase 1—strict search—20 seconds: Player is to find an eligible match with the non-expanded rules.

Phase 2—expanding search—20 seconds: Rules which support expansion are linearly interpolated from their non-expanded form to their expanded form over a period of time.

Phase 3—expanded search—20 seconds: All rules are fully expanded.

Phase 4—soft search—infinite seconds: Rules not marked as hard requirements are dropped.

In some implementations, the length of time spent in each phase can be controlled by the platform and adjusted over time based on gathered real-world data; or in some implementations, developers can adjust the time spent in each phase.

Rule reciprocity: search expansion may create an edge case where player A is eligible to join player B but player B is not eligible to join player A. In an example, there is a max difference rule on Player. Skill with an initial threshold of 200 and an expanded threshold of 500. Player A has Player.Skill of 1000 and player B has Player.Skill of 1300. If player A has been searching for 30 seconds and player B starts searching, since player A has been waiting, their Player.Skill rule evaluation has a high enough threshold to consider player B eligible. However, player B would not see player A as eligible with the non-expanded threshold. In some implementations, reciprocity of rules may not be guaranteed—joins are eligible in a single direction to be allowed.

Latency tolerance: In some implementations, developers are not provided direct control over latency since it cannot always be guaranteed. In some implementations, a “latency tolerance” rule can be used, with enumeration for strict, default, open. strict: For each player that is joining, find the lowest possible latency to each player and try to guarantee that the player's latency will be within a threshold latency of the best instance. For queue-based joins starting a new instance, an instance that is located centrally within all players can be selected.

In some implementations, a ‘PlatformAttribute’ class allows the system to access matchmaking data. A PingAttribute instance of PlatformAttribute can convert ping (latency) into a low/medium/high latency attribute (as integers 1, 2, 3). The choice of thresholds for these categories can be based on impact of latency on player engagement and/or adaptive to different genres or user characteristics. This is different from the standard player and server attributes, since it is a function of both. If the developer selects the ping rule in the UI, the logic creates a MaximumValueRule instance (from the same generic rule class). Example: PlatformAttribute can be used to get device type, age, voice chat, or other characteristics.

FIG. 7 illustrates an example method to perform customized matchmaking for users of virtual experiences based on developer provided matchmaking rules, in accordance with some implementations.

In some implementations, method 700 (and any other method/operations described herein) can be implemented, for example, on virtual experience server 102 described with reference to FIG. 1. In some implementations, some or all portions of the method 700 can be implemented on one or more user devices 110 as shown in FIG. 1, on one or more developer devices 130, or on one or more server device(s) 102, and/or on a combination of developer device(s), server device(s), and user device(s). In described examples, the implementing system includes one or more digital processors or processing circuitry (“processors”), and one or more storage devices (e.g., data store 120 or other storage). In some implementations, different components of one or more servers and/or clients can perform different blocks or other parts of the method 700. In some examples, a first device is described as performing blocks of method 700. Some implementations can have one or more blocks of method 700 performed by one or more other devices (e.g., other user devices or server devices) that can send results or data to the first device.

In some implementations, the method 700 (or any other method described herein), or portions of the method(s), can be initiated automatically by a system. In some implementations, the implementing system is a first device. For example, the method (or portions thereof) can be periodically performed, or performed based on one or more particular events or conditions (e.g., a request received from a user to perform method 700, receiving a user request to join a virtual experience, receiving a request from a user to teleport to a different place in a virtual experience, and/or one or more other conditions occurring which can be specified in settings read by the method). Method 700 may begin at block 710.

At block 710, a request may be received from a user device of a requesting user to join a particular virtual experience of a plurality of virtual experiences hosted on a virtual experience platform.

Block 710 may be followed by block 720.

At block 720, virtual experience instances of the particular virtual experience that are in progress are identified. In some implementations, the virtual experience instances may be virtual experience instances executing on a respective server of the virtual experience platform.

Block 720 may be followed by block 730.

At block 730, a first set of virtual experience instances eligible for the requesting user to join is determined. In some implementations, the first set of virtual experience instances is a subset of the identified virtual experience instances.

In some implementations, determining the first set of virtual experience instances may include identifying the virtual experience instances of the particular virtual experience that are in progress and have at least one of one or more empty player slots operative to receive a new user, or a reserve status that is available to receive the requesting user.

Block 730 may be followed by block 740.

At block 740, one or more matchmaking rules that are associated with the particular virtual experience are obtained. In some implementations, obtaining the one or more matchmaking rules may include providing a user interface to a developer of the particular virtual experience to provide the one or more matchmaking rules, where the user interface includes information indicative of attributes and/or signals that can be specified in the one or more matchmaking rules.

In some implementations, in response to providing the user interface, developer input that specifies the one or more matchmaking rules may be received, via the user interface. In some implementations, each matchmaking rule specified and/or selected by the developer of the virtual experience includes at least one of the attributes and/or signals included in the user interface.

In some implementations, obtaining the one or more matchmaking rules may include receiving, via a user interface executed by at least one processor and displayed by a display device, first input from a developer that specifies one or more types of player attributes for players of a specified experience provided by the developer. Additionally, second input may be received, via the user interface, from the developer that specifies one or more matchmaking rules that provide a result indicating eligibility of an instance of the specified experience based on the one or more types of player attributes.

In some implementations, determining the third set of virtual experience instances may include evaluating based on the one or more matchmaking rules, wherein the one or more matchmaking rules are evaluated based on the player attributes associated with the requesting user and attributes associated with one or more existing players connected to the virtual experience instances of the particular virtual experience that are in progress. Block 740 may be followed by block 750.

At block 750, a second set of virtual experience instances that satisfy the one or more matchmaking rules is determined.

In some implementations, method 700 may further include determining a first set of player attributes associated with the requesting user and is associated with the virtual experience, where the types of the player attributes determined have been selected by a developer of the virtual experience. In some implementations, method 700 may further include determining a respective set of player attributes that is associated with the virtual experience and is associated with each of one or more existing players connected to each virtual experience instance of the first set of virtual experience instances.

In some implementations, determining the second set of virtual experience instances may include evaluating the one or more matchmaking rules based on the first set of player attributes and based on the respective sets of player attributes.

In some implementations, determining the second set of virtual experience instances may further include determining a respective set of server attributes associated with each virtual experience instance of the first set of virtual experience instances, wherein types of the server attributes have been selected by a developer of the particular virtual experience.

In some implementations, determining the second set of virtual experience instances may include evaluating the one or more matchmaking rules based on the first set of player attributes, the respective sets of player attributes, and the respective sets of server attributes.

In some implementations, the first set of player attributes and the respective sets of player attributes include at least one of a player skill rating attribute or a play mode attribute. In some implementations, the set of server attributes includes at least one of: play mode, or a current number of players in the virtual experience instance.

In some implementations, the one or more matchmaking rules enable a boolean evaluation of a virtual experience instance and provide a true/false result of the evaluation. In some implementations, the one or more matchmaking rules may include a maximum difference rule that provides a true result for the evaluated virtual experience instance if a difference between a skill rating attribute in the first set of player attributes is within a threshold value range of all skill rating attributes of existing players connected to the evaluated virtual experience instance. In some other implementations, the one or more matchmaking rules may include an exact match rule that provides a true result for the evaluated virtual experience instance if the first set of player attributes exactly matches a server attribute of the evaluated virtual experience instance. In some implementations, the second set of virtual experience instances is a subset of the first set of virtual experience instances. Block 750 may be followed by block 760.

At block 760, a respective score is determined for individual virtual experience instances in the second set of virtual experience instances based on one or more matchmaking scoring criteria. In some implementations, the matchmaking scoring criteria are distinct from the one or more matchmaking rules.

In some implementations, determining the respective score for each virtual experience instance in the second set of virtual experience instances based on one or more matchmaking scoring criteria may include determining characteristics related to the requesting user and existing players connected to each experience instance, wherein the characteristics include one or more of: social connections, age group, language preference, geographic location, voice chat preference, network connection to each experience instance, or latency to each experience instance, and scoring the requesting user and each of the existing players connected to each experience instance based on the determined characteristics. Block 760 may be followed by block 770.

At block 770, a third set of virtual experience instances wherein the third set of virtual experience instances is determined based on the respective scores determined for individual virtual experience instances in the second set of virtual experience instances.

In some implementations, the third set of virtual experience instances is a subset of the second set of virtual experience instances. Block 770 may be followed by block 780.

At block 780, the user device is connected to (or caused to be connected to) the server that hosts a particular one of the third set of virtual experience instances.

In some implementations, the particular one of the third set of virtual experience instances may be the virtual experience instance with a highest score of the respective scores. In some implementations, the particular one of the third set of virtual experience instances may be selected randomly from the third set.

In some implementations, the particular one of the third set of virtual experience instances may be any virtual experience instance with a respective score that meets a threshold score. For example, a first identified virtual experience instance that is associated with a respective score that meets a threshold score may be automatically selected as the particular one of the third set of virtual experience instances.

Subsequent to participation in a virtual experience, one or more attributes (e.g., player attributes) may be adjusted and stored on the virtual experience platform. For example, a request may be received from a user device to disconnect from a server that hosts the one of the third set of virtual experience instances (e.g., at the end of a virtual experience session). In response to receiving the request, the user device may be caused to disconnect from a server that hosts the one of the third set of virtual experience instances. Upon disconnection, the first set of player attributes may be updated based on parameters obtained from the one of the third set of virtual experience instances and the updated first set of player attributes may be stored in a persistent database. The updated first set of player attributes may be retrieved and utilized subsequently (e.g., when a fresh request is received from the user to join a virtual experience).

Method 700 and any other method described herein, or portions thereof, may be repeated any number of times using additional inputs. Blocks 710-780 (and the blocks of any other method described herein) may be performed (or repeated) in a different order than described above and/or one or more steps/operations can be omitted, added, modified, combined, replaced, etc.

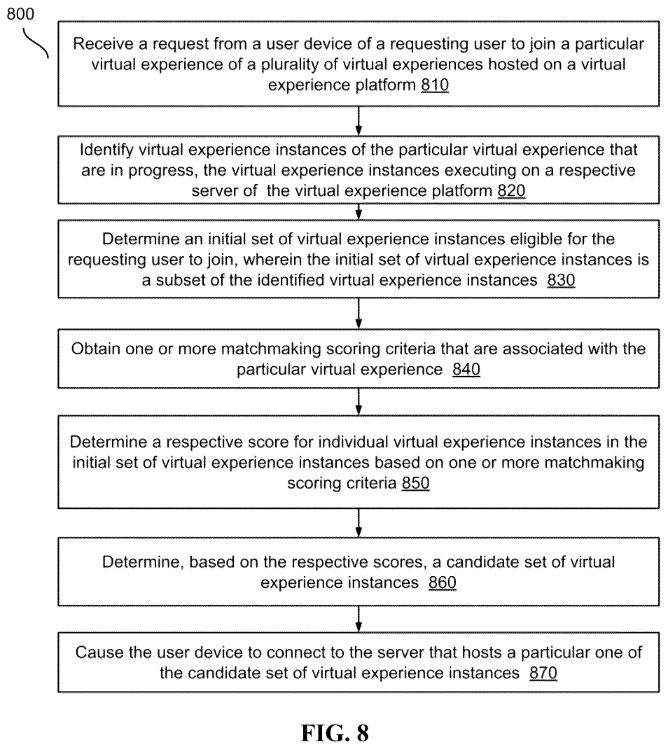

FIG. 8 illustrates an example method to perform customized matchmaking for users of virtual experiences based on developer provided matchmaking scoring criteria, in accordance with some implementations.

In some implementations, the method 800, or portions of the method, can be initiated automatically by a system. In some implementations, the implementing system is a first device. For example, the method (or portions thereof) can be periodically performed, or performed based on one or more particular events or conditions, e.g., a request received from a user to perform method 800, receiving a user request to join a virtual experience, receiving a request from a user to teleport to a different place in the virtual experience, and/or one or more other conditions occurring which can be specified in settings read by the method. Method 800 may begin at block 810.

At block 810, a request is received from a user device of a requesting user to join a particular virtual experience of a plurality of virtual experiences hosted on a virtual experience platform. Block 810 may be followed by block 820.

At block 820, virtual experience instances of the particular virtual experience that are in progress are identified. In some implementations, each of the virtual experience instances may be executing on a respective server of the virtual experience platform. Block 820 may be followed by block 830.

At block 830, an initial set of virtual experience instances eligible for the requesting user to join may be determined. In some implementations, the initial set of virtual experience instances is a subset of the identified virtual experience instances.

In some implementations, determining the initial set of virtual experience instances may include identifying the virtual experience instances of the particular virtual experience that are in progress and have at least one of one or more empty player (user) slots operative to receive a new user, or a reserve status that is available to receive the requesting user. Block 830 may be followed by block 840.

At block 840, one or matchmaking scoring criteria that are associated with the particular virtual experience may be obtained.

In some implementations, obtaining the one or more matchmaking scoring criteria may include providing a user interface to a developer of the particular virtual experience to provide the one or more matchmaking scoring criteria. In some implementations, the user interface may include information indicative of candidate attributes that can be specified in the one or more matchmaking scoring criteria (e.g., via drop down options provided within the user interface).

In some implementations, developer input that specifies the one or more matchmaking scoring criteria may be received via the user interface. In some implementations, each matchmaking scoring criteria includes at least one of the candidate attributes, and may include additional attributes specified by the developer.

In some implementations, the matchmaking scoring criteria may include one or more attributes from the candidate attributes, and a respective weight for each of the one or more attributes.

As described earlier, an attribute may be any property that is used in matchmaking scoring. It can be a number (e.g., a player's Elo rating) or a string (e.g., a player's language). Attributes represent “raw signal values” before any processing is performed. In some scenarios, attributes may be custom attributes, which are developer-defined properties, defined on a universe level, and which may be utilized to characterize (e.g., describe) either a player or a server.

Player attribute: A characteristic of a player, such as their preferred game mode or skill level (e.g., Elo rating), or as server attributes, which are a characteristic of a server, e.g., like its response time (ping) or active game mode.

Server attribute: A characteristic of a server, like its response time (ping) or active game mode.

In some implementations, the attributes may include numeric attributes as well as categorical attributes.

Numeric attributes: The score compares the difference between a player's attribute and the server's average, with larger differences lowering or increasing the score. For example, if the player's skill level is 80, and the server's average skill level is 70, the closer they are, the higher the score. This score may then be multiplied by a custom weight set by the developer.

Function for numeric attribute {x} negative curve:

$${f}_{i} ( x ) = 1 - abs ( JoiningPlayer . \{ x \} - avg ( Server . Players . \{ x \} ) / \{ Max RelevantDifference \}$$

Function for numeric attribute {x} positive curve:

$${f}_{i} ( x ) = abs ( JoiningPlayer . \{ x \} - avg ( Server . Players . \{ x \} ) / \{ Max RelevantDifference \}$$

Categorical attributes: The score is based on how common the player's attribute is among the server's capacity of players. For example, if a player's preferred language is English and 70% of the server's capacity of players also speak English, the score would reflect this commonality. This is also multiplied by a weight defined by the developer.

Function for categorical attribute {x} negative curve:

$${f}_{i} ( x ) = 1 - count ( JoiningPlayer . \{ x \} == Server . Players . \{ x \} ) / Server . Capacity$$

Function for categorical attribute {x} positive curve:

$${f}_{i} ( x ) = count ( JoiningPlayer . \{ x \} == Server . Players . \{ x \} ) / Server . Capacity$$

In some implementations, attributes may be further processed (e.g., mathematically or computationally) to derive signals based on the attributes. For example, signals may be determined by applying transformations (e.g., scaling or aggregation) and may be utilized to fit the matchmaking scoring system.

In some implementations, a weight may refer to a positive value that describes the relevant importance of a signal in the scoring process. For example, higher weights may mean that the associated signal and/or attribute has a bigger impact.

Block 840 may be followed by block 850.

At block 850, a respective score for each individual virtual experience instance in the initial set of virtual experience instances is determined based on the one or more matchmaking scoring criteria. For example, for each individual virtual experience instance in the initial set, method 800 may include computing, based on the matchmaking scoring criteria, a respective score associated with each of the one or more attributes and computing the score for the individual virtual experience instance as a weighted sum of the respective scores associated with the one or more attributes.

For example, in some implementations, a weighted sum (WS) score may be expressed as a linear sum of weighted terms:

$$WS = {\sum }_{i} {w}_{i} * {f}_{i} ( x )$$

$$where$$

$${w}_{i} : weight for signal i$$

$${f}_{i} ( x ) : Function for signal i$$

In some implementations, prior to computing the respective score for each individual virtual experience instance in the initial set of virtual experience instances, method 800 may include obtaining values for the one or more attributes included in the matchmaking scoring criteria for each of the initial set of virtual experiences. For example, a data store associated with the virtual experience platform may be polled (e.g., queried) to obtain values for the one or more attributes included in the matchmaking scoring criteria for each of the initial set of virtual experiences.

In some implementations, signal scores for each of the initial set of virtual experiences may be computed based on the obtained values for the one or more attributes included in the matchmaking scoring criteria. In some implementations, computing the signal scores may include computing a predetermined function of the obtained values for the one or more attributes included in the matchmaking scoring criteria.

In some implementations, the predetermined function is one of an increasing linear function and a decreasing linear function. In some implementations, predetermined functions operating on selected attributes may be non-linear. In some implementations, the predetermined function utilized to operate on an attribute that corresponds to a number of friends of the requesting user currently participating in the initial set of virtual experience instances may be a non-linear function.

Block 850 may be followed by block 860.

At block 860, a candidate set of virtual experience instances is determined based on the respective scores. In some implementations, the candidate set of virtual experience instances is a subset of the initial set of virtual experience instances. Block 860 may be followed by block 870.

At block 870, the user device is caused to connect to the server that hosts a particular virtual experience instance of the candidate set of virtual experience instances.

In some implementations, the particular virtual experience instance of the candidate set of virtual experience instances (that the user device is caused to connect to) is associated with the highest score of the respective scores.

In some implementations, analytics generated by the matchmaking engine may be utilized to provide recommendations to developers to further improve matchmaking performance. For example, in some implementations, a join performance of the particular virtual experience may be monitored and based on the join performance, analytics, metrics, and/or recommendation(s) may be provided to a developer of the particular virtual experience to adjust matchmaking scoring criteria. In some implementations, signal metrics such as age difference between participants, common language ratio, average ping, etc., may be provided to developers

In some implementations, analytics data for a virtual experience may be provided to a developer via an analytics option in a customized matchmaking user interface. This option can provide a variety of graphs and other analytics metrics for the developer to view and easily evaluate the effects of the developer's custom matchmaking rules on the experience. Analytics can provide developers with information about how their defined rules have been performing with respect to player participation in experience instances.

For example, a percentage of successful joins by players to an instance over a day time period (out of all join requests) may be determined for when an associated rule is applied. In some implementations, the system can track how many players would have successfully joined if only a particular one of the rules had been in effect.

Developers can assess the impact of custom rules on game joins. With rule-based breakdowns, creators can analyze the performance of each rule. If the rule(s) results in a lower percentage of joins, developers can make adjustments (e.g., relaxations) to the rule conditions.

In further examples, analytics can include data or graphs that indicate the percentage or number of occurrences that each rule was matched (valid/eligible), that each rule was expanded or relaxed, that each rule was cancelled, etc. Analytics can indicate instance occupancy and the number of new instances created because of the rules. Analytics can indicate a distribution of each attribute. Analytics can indicate adoption rate (the percentage of developers who use custom matchmaking features); player engagement (the increase in play time for experiences with custom matchmaking enabled); and player retention (changes in player retention rates to assess if custom matchmaking helps prevent players quitting an experience or the platform).

In further examples, analytics can indicate the number of instances filtered based on custom matchmaking rules, rules matched, canceled, relaxed, etc. For queue-based matchmaking, analytics can indicate the wait time for a match and abandon rate (rate that players abandon an experience before it is completed or after a short period of time).

In some implementations, assets associated with the particular virtual experience may be automatically monitored in order to provide recommendations to developers to further improve matchmaking performance. For example, a developer may make changes to a virtual experience whereby modified matchmaking scoring criteria (e.g., new attributes and/or signals, adjusted weights, etc.) may provide improved matchmaking performance.

In some implementations, changes of developer configured matchmaking configuration may be detected, and an annotation (e.g., a vertical line) may be provided on all analytics chart(s) to enable the developer to track a timestamp associated with the changes.

In some implementations, method 800 may include detecting a change in assets associated with the particular virtual experience, and in response to detecting the change, providing an update user interface to the developer of the particular virtual experience to update the matchmaking scoring criteria, and receiving via the update user interface updated matchmaking scoring criteria for the particular virtual experience.

In some implementations, the assets may include a codebase associated with the virtual experience, new or modified virtual objects utilized in the virtual experience, additional modes such as gameplay modes of the virtual experience, gameplay speed, etc.

In some implementations, the matchmaking scoring criteria may be automatically determined based on text inputs provided by the developer. For example, in some implementations, the matchmaking scoring criteria may include text input received from a developer of the virtual experience. In some implementations, a trained machine learning (ML) model may be applied to the received text input to determine one or more weights or attributes.

For example, the text input may include phrases or expressions such as “my game is sensitive to latency,” “my game requires matchmaking based on experience playing the game,” “my game is a strategy game not sensitive to latency, but it is preferable to have ‘friends’ join instances with others they know,” etc. The trained ML model, e.g., a large language model (LLM) may be utilized to automatically generate suitable attributes, weights, and/or scoring criteria based on the text input.

In some implementations, a trained ML model may be applied to developer provided input(s) in conjunction with session level data and/or matchmaking decisions data for a particular time period to generate a recommendation on a set of weights to use that may boost join performance and/or other metrics of interest.

Method 800, or portions thereof, may be repeated any number of times using additional inputs. Blocks 810-870 may be performed (or repeated) in a different order than described above and/or one or more steps can be omitted.

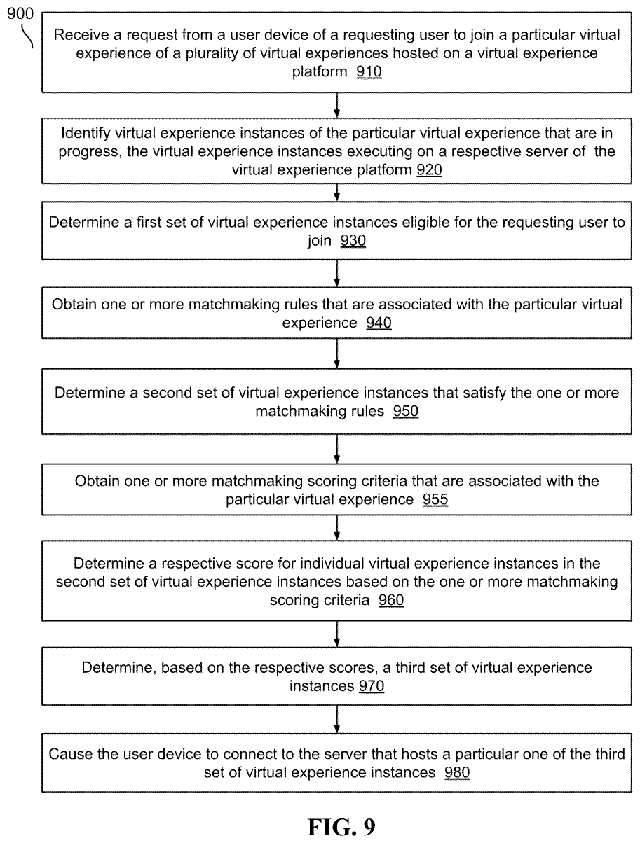

FIG. 9 illustrates an example method to perform customized matchmaking for users of virtual experiences based on developer provided matchmaking rules and developer provided matchmaking scoring criteria, in accordance with some implementations.

In some implementations, method 900, or portions of the method, can be initiated automatically by a system. In some implementations, the implementing system is a first device. For example, the method (or portions thereof) can be periodically performed, or performed based on one or more particular events or conditions (e.g., a request received from a user to perform method 900, receiving a user request to join a virtual experience, receiving a request from a user to teleport to a different place in a virtual experience, and/or one or more other conditions occurring which can be specified in settings read by the method). Method 900 may begin at block 910.

At block 910, a request may be received from a user device of a requesting user to join a particular virtual experience of a plurality of virtual experiences hosted on a virtual experience platform.

Block 910 may be followed by block 920.

At block 920, virtual experience instances of the particular virtual experience that are in progress are identified. In some implementations, the virtual experience instances may be virtual experience instances executing on a respective server of the virtual experience platform.

Block 920 may be followed by block 930.

At block 930, a first set of virtual experience instances eligible for the requesting user to join is determined. In some implementations, the first set of virtual experience instances is a subset of the identified virtual experience instances.

In some implementations, determining the first set of virtual experience instances may include identifying the virtual experience instances of the particular virtual experience that are in progress and have at least one of one or more empty player slots operative to receive a new user, or a reserve status that is available to receive the requesting user.

Block 930 may be followed by block 940.

At block 940, one or more matchmaking rules that are associated with the particular virtual experience are obtained. In some implementations, obtaining the one or more matchmaking rules may include providing a user interface to a developer of the particular virtual experience to provide the one or more matchmaking rules, where the user interface includes information indicative of attributes and/or signals that can be specified in the one or more matchmaking rules.

In some implementations, in response to providing the user interface, developer input that specifies the one or more matchmaking rules may be received, via the user interface. In some implementations, each matchmaking rule specified and/or selected by the developer of the virtual experience includes at least one of the attributes and/or signals included in the user interface.

In some implementations, obtaining the one or more matchmaking rules may include receiving, via a user interface executed by at least one processor and displayed by a display device, first input from a developer that specifies one or more types of player attributes for players of a specified experience provided by the developer. Additionally, second input may be received, via the user interface, from the developer that specifies one or more matchmaking rules that provide a result indicating eligibility of an instance of the specified experience based on the one or more types of player attributes.

In some implementations, determining the third set of virtual experience instances may include evaluating based on the one or more matchmaking rules, wherein the one or more matchmaking rules are evaluated based on the player attributes associated with the requesting user and attributes associated with one or more existing players connected to the virtual experience instances of the particular virtual experience that are in progress. Block 940 may be followed by block 950.

At block 950, a second set of virtual experience instances that satisfy the one or more matchmaking rules is determined.

In some implementations, method 900 may further include determining a first set of player attributes associated with the requesting user and is associated with the virtual experience, where the types of the player attributes have been selected by a developer of the virtual experience. In some implementations, method 900 may further include determining a respective set of player attributes that is associated with the virtual experience and is associated with each of one or more existing players connected to each virtual experience instance of the first set of virtual experience instances.

In some implementations, determining the second set of virtual experience instances may include evaluating the one or more matchmaking rules based on the first set of player attributes and based on the respective sets of player attributes.

In some implementations, determining the second set of virtual experience instances may further include determining a respective set of server attributes associated with each virtual experience instance of the first set of virtual experience instances, wherein types of the server attributes have been selected by a developer of the particular virtual experience.

In some implementations, determining the second set of virtual experience instances may include evaluating the one or more matchmaking rules based on the first set of player attributes, the respective sets of player attributes, and the respective sets of server attributes.

In some implementations, the first set of player attributes and the respective sets of player attributes include at least one of a player skill rating attribute or a play mode attribute. In some implementations, the set of server attributes includes at least one of: play mode, or a current number of players in the virtual experience instance.

In some implementations, the one or more matchmaking rules enable a boolean evaluation of a virtual experience instance and provide a true/false result of the evaluation. In some implementations, the one or more matchmaking rules may include a maximum difference rule that provides a true result for the evaluated virtual experience instance if a difference between a skill rating attribute in the first set of player attributes is within a threshold value range of all skill rating attributes of existing players connected to the evaluated virtual experience instance. In some other implementations, the one or more matchmaking rules may include an exact match rule that provides a true result for the evaluated virtual experience instance if the first set of player attributes exactly matches a server attribute of the evaluated virtual experience instance. In some implementations, the second set of virtual experience instances is a subset of the first set of virtual experience instances. Block 950 may be followed by block 955.

At block 955, one or more matchmaking scoring criteria that are associated with the particular virtual experience are obtained. Block 955 may be followed by block 960.

At block 960, a respective score is determined for individual virtual experience instances in the second set of virtual experience instances based on one or more matchmaking scoring criteria. In some implementations, the matchmaking scoring criteria are distinct from the one or more matchmaking rules.

In some implementations, determining the respective score for each virtual experience instance in the second set of virtual experience instances based on one or more matchmaking scoring criteria may include determining characteristics related to the requesting user and existing players connected to each experience instance, wherein the characteristics include one or more of: social connections, age group, language preference, geographic location, voice chat preference, network connection to each experience instance, or latency to each experience instance, and scoring the requesting user and each of the existing players connected to each experience instance based on the determined characteristics. Block 960 may be followed by block 970.

At block 970, a third set of virtual experience instances wherein the third set of virtual experience instances is determined based on the respective scores determined for individual virtual experience instances in the second set of virtual experience instances.

In some implementations, the third set of virtual experience instances is a subset of the second set of virtual experience instances. Block 970 may be followed by block 980.

At block 980, the user device is connected to (or caused to be connected to) the server that hosts a particular one of the third set of virtual experience instances.

In some implementations, the particular one of the third set of virtual experience instances may be the virtual experience instance with the highest score of the respective scores. In some implementations, the particular one of the third set of virtual experience instances may be selected randomly from the third set.

In some implementations, the particular one of the third set of virtual experience instances may be any virtual experience instance with a respective score that meets a threshold score. For example, a first identified virtual experience instance that is associated with a respective score that meets a threshold score may be automatically selected as the particular one of the third set of virtual experience instances.

Subsequent to participation in a virtual experience, one or more attributes, e.g., player attributes may be adjusted and stored on the virtual experience platform. For example, a request may be received from a user device to disconnect from a server that hosts one of the third set of virtual experience instances, e.g., at the end of a virtual experience session. In response to receiving the request, the user device may be caused to disconnect from the connected instance. Upon disconnection, the first set of player attributes may be updated based on parameters obtained from the one of the third set of virtual experience instances and the updated first set of player attributes may be stored in a persistent database. The updated first set of player attributes may be retrieved and utilized subsequently (e.g., when a fresh request is received from the user to join a virtual experience).

Method 900, or portions thereof, may be repeated any number of times using additional inputs. Blocks 910-980 may be performed (or repeated) in a different order than described above and/or one or more steps can be omitted.

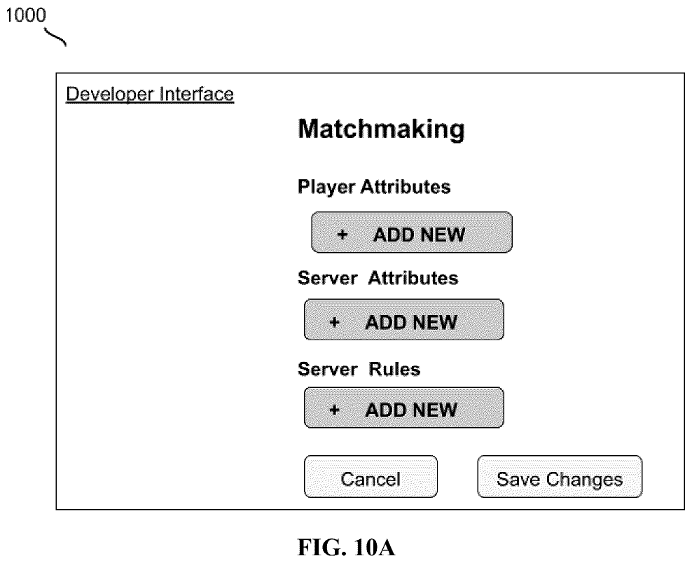

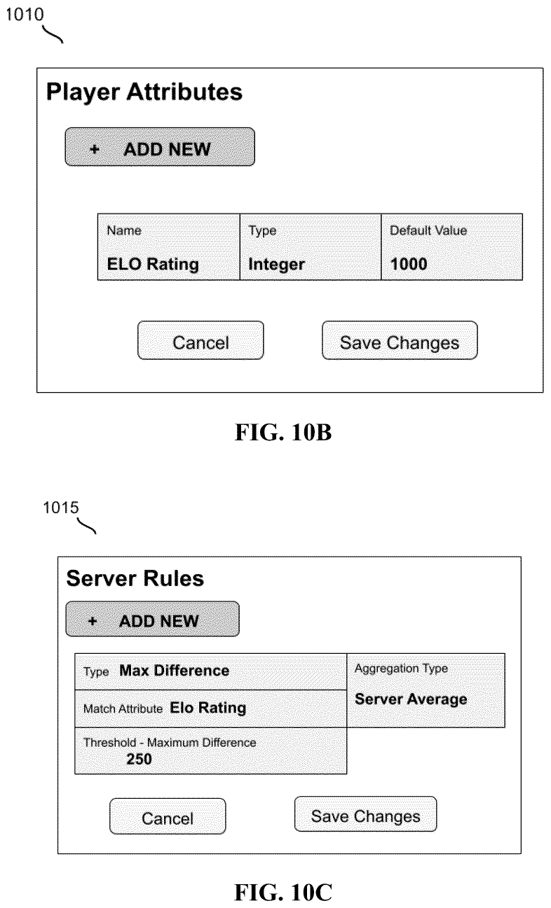

FIGS. 10-13 are examples of a user interface allowing customization of matchmaking features by a developer, according to some implementations. The various user interface(s) shown in the figures may be provided by the I/O interface(s) 114 and/or 134 of FIG. 1, for example. The user interface may enable developers to define parameters for skill-based matchmaking for a particular experience, so that players of similar skill can be placed in instances of the experience and will be able to play a balanced and competitive match. For example, players would be able to play the same difficulty level in a game, have a similar skill rating (e.g., within a threshold skill rating range of each other), and advanced players and inexperienced players play with other players of similar skill.

FIG. 10A illustrates a user interface layout that may be utilized by a developer of a virtual experience to customize matchmaking attributes for the virtual experience, in accordance with some implementations.

In FIG. 10A, an example is shown of a displayed user interface of a developer experience editor of a virtual experience platform. A developer has accessed the developer user interface in association with a particular experience created by the developer, and has navigated to a custom matchmaking section of the experience editor. As shown, the customized matchmaking section includes three editable parameter sections: player attributes, server attributes, and server rules, that are all associated with the particular virtual experience. A list of the parameters is displayed; in this case, none of these parameters have yet been defined for this experience so no parameters are displayed. The developer can select the respective “add new” button under each of the parameter sections to add a new parameter of that type.

FIG. 10B illustrates a user interface layout that may be utilized by a developer of a virtual experience to add new player attributes for use in customized matchmaking, in accordance with some implementations.

In FIG. 10B, the developer has selected the “add new” button in the player attributes section of the user interface of FIG. 10A. In response to the selection, a group of three fields is displayed, in which the developer can enter player attribute data, e.g., via direct input, drop-down menu, etc. In this example, the developer adds an Elo rating for each player of the associated experience by selecting the “add new” button and specifying a name (“Elo rating”), type (“integer”), and default value (“1000”). This provides a player attribute for a skill-based matchmaking type of use case.

FIG. 10C illustrates a user interface layout that may be utilized by a developer of a virtual experience to add server rules for use in customized matchmaking, in accordance with some implementations. In FIG. 10C, the developer has selected the “add new” button in the server rules section of the user interface of FIG. 10A. In response to the selection, a group of three fields is displayed, in which the developer can define a server rule, e.g., via direct input, drop-down menu, etc. In this example, the developer defines a rule that has a type of max difference, operates on a player attribute of ELO Rating, has a threshold of 250 for the max difference, and has an aggregation type of server average.

After each round of play in the experience instance using these example player attributes and rules, each player's ELO rating may be updated as desired by the developer (e.g., in an automated manner using code via an API such as the Lua API). For example, the following example code (e.g., provided by a developer) can be used to update the ELO rating of each player after a round of play of the experience (e.g., game):

```
local MatchmakingService = game:GetService(“MatchmakingService”)
function OnMatchEnded(players, winners, losers)
  For player in pairs(players) do
    local updatedElo = CalculateUpdatedElo(player, winners,
losers)
    MatchmakingService:SetPlayerVariableAsync(player, “Elo
Rating”, updatedElo)
  end
end
```

In another use case, the developer may desire that players be able to choose between different play modes of an experience so that the players can play the game mode that they prefer, when they want to. Such play modes can include solo, duo, squads, casual, ranked/competitive, roleplay, combat, duels (2 players), free for all (more than 2 players), teams (more than 2 players), etc.

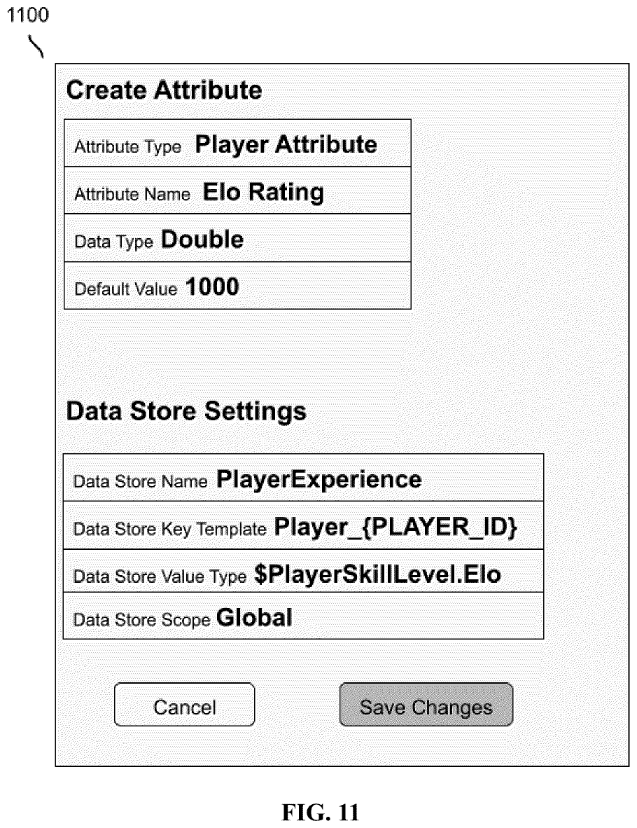

FIG. 11 illustrates a user interface layout that may be utilized by a developer of a virtual experience to configure a new attribute for use in customized matchmaking, in accordance with some implementations. In FIG. 11, the developer has selected a “create attribute” button in the attributes section of the user interface. In response to the selection, a group of fields is displayed, in which the developer can enter attribute data. In this example, the fields include an attribute type, which can be player attribute or server attribute (here, player attribute). The fields include name, which is a developer-defined label for the attribute. The fields include data type (integer, floating point, etc.), and default value for this attribute. The interface also includes data store settings, in which a developer can specify a template and other settings for the attribute.

The developer can be enabled, via the user interface, to select a “create rule” button in a rule section of the user interface. In response to the selection, a group of fields may be displayed, in which the developer can enter rule data. In an illustrative example, the fields may include a template, which can be a skill-based match making rule template, a play modes rule template, or a custom rule template which allows the developer to create their own rule template. Rule templates allow a developer to create a rule as a template that provides a number of fields indicating important characteristics of a rule for a developer to specify. The group of fields also includes a Place to indicate which particular place in the experience that this rule will apply.

When a developer has selected the skill-based match making rule template, a set of fields may be displayed to allow the developer to specify the rule. For example, a rule type (e.g., Max Diff), a name of the rule, a place where the rule is applied, a match attribute that is the player attribute to be evaluated, a threshold that is the allowable difference between the requesting player's attribute value and a value for the instance, and an aggregation type that determines how the value for the instance is determined (e.g., by averaging the attribute values of the existing players in the instance).

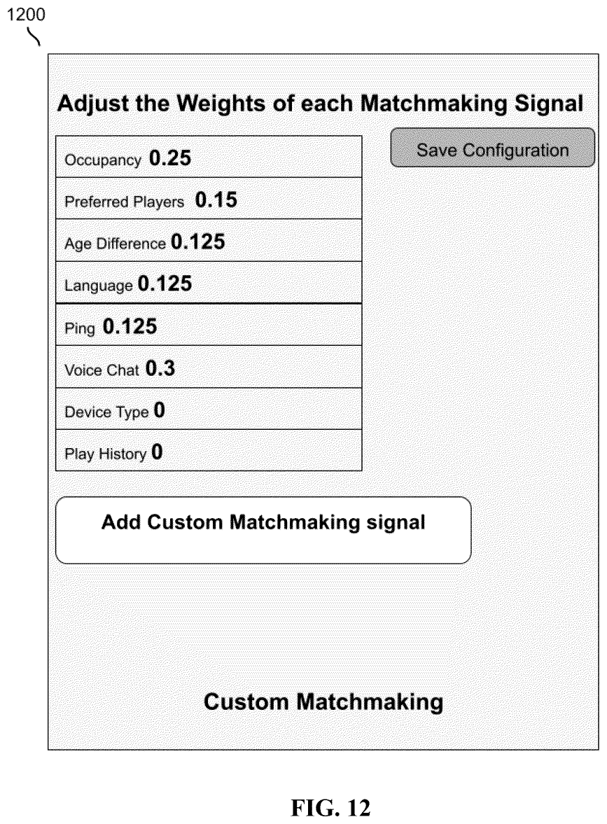

FIG. 12 illustrates a user interface layout that may be utilized by a developer of a virtual experience to provide matchmaking scoring criteria for use in customized matchmaking, in accordance with some implementations. In this example, a developer wishes to define weights for matchmaking signal(s) that can be used for skill-based matchmaking for a particular experience, so that players of similar skill can be placed in instances of the experience and will be able to play a balanced and competitive match. For example, players would be able to play the same difficulty level in a game, have a similar skill rating (e.g., within a threshold skill rating range of each other), and advanced players and inexperienced players play with other players of similar skill.

As depicted in FIG. 12, the user interface enables a developer to select signals, and assign suitable weights to each signal. The user interface enables use of existing platform signals as well as add custom signals. Further, the user interface may enable the developer to preview the impact of weight changes of signals on server assignments.

In this illustrative example, a developer has accessed the developer user interface in association with a particular experience created by the developer, and has navigated to a custom matchmaking section of an experience editor. As shown, the customized matchmaking section includes a display of a plurality of matchmaking signals and corresponding weights that may be adjusted by the developer.

In some implementations, default values may be populated and provided by the virtual experience platform. Example matchmaking signals include occupancy, preferred players, age difference, language, ping, voice chat, device type, play history, etc. The user interface may also display a server score preview based on the provided weights that indicates respective server scores that are computed by the platform. The signal weights may be tested with different server characteristics, as depicted in FIG. 12.

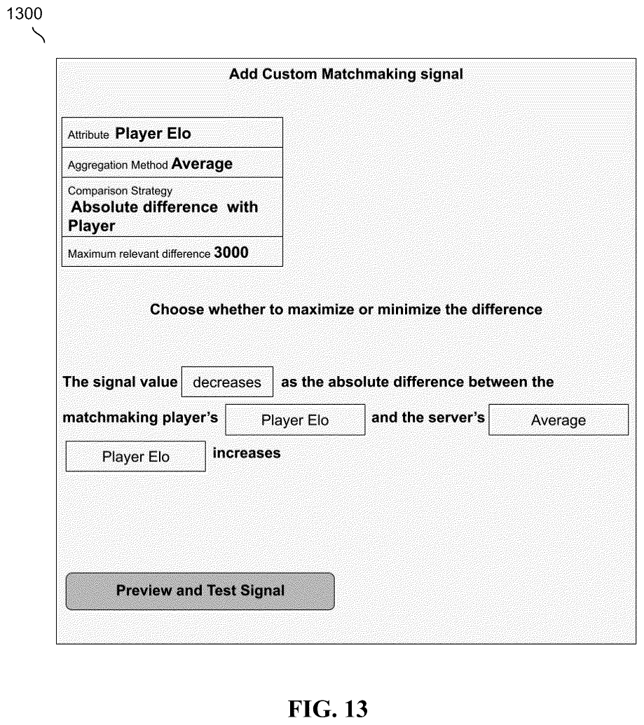

FIG. 13 illustrates a user interface layout that may be utilized by a developer of a virtual experience to provide additional matchmaking scoring criteria for use in customized matchmaking, in accordance with some implementations.

As depicted in FIG. 13, the user interface enables detailed customization of a signal and/or attribute.

Some implementations described herein may include a computer-implemented method that includes described operations performed or caused/controlled to be performed by a processor of a system. Some implementations may include a system that includes a processor and a memory coupled to the processor. The memory may have instructions stored thereon that, when executed by the processor, cause the processor to perform or control performance of operations that include one or more of the features of the methods described above. Some implementations may include a non-transitory computer-readable medium with instructions stored thereon that, when executed by a processor, cause the processor to perform or control performance of operations that can be similar to features of the techniques and/or systems described herein.

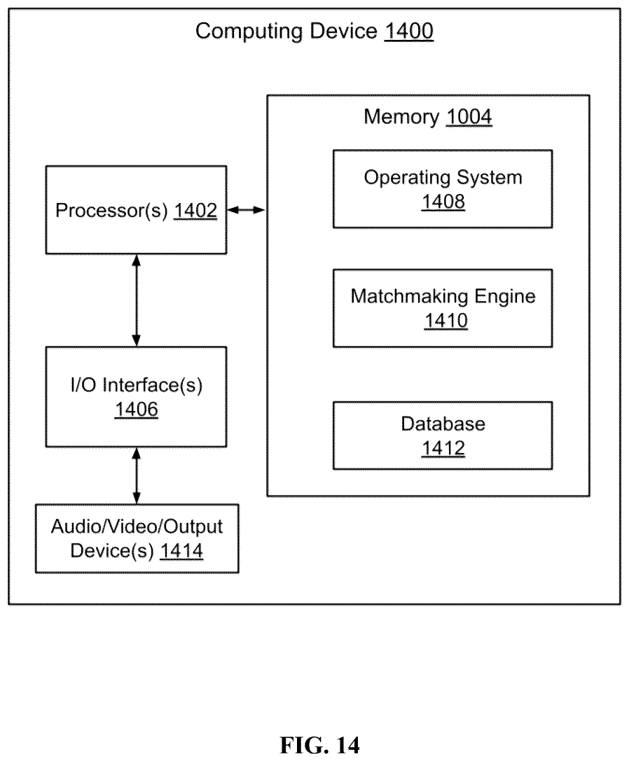

FIG. 14 is a block diagram of an example computing device 1400 which may be used to implement one or more features described herein, in accordance with some implementations. In one example, device 1400 may be used to implement a computing device (e.g., 102, 110, and/or 130 of FIG. 1), and perform appropriate method implementations described herein. Computing device 1400 can be any suitable computer system, server, or other electronic or hardware device. For example, the computing device 1400 can be a mainframe computer, desktop computer, workstation, portable computer, or electronic device (portable device, mobile device, cell phone, smart phone, tablet computer, television, TV set top box, personal digital assistant (PDA), media player, game device, wearable device, etc.). In some implementations, device 1400 includes a processor 1402, a memory 1404, input/output (I/O) interface 1406 (which may be embodied by the I/O interface 114 or 134 of FIG. 1), and audio/video input/output devices 1414 (e.g., display screen, touchscreen, display goggles or glasses, audio speakers, microphone, etc.).

Processor 1402 can be one or more processors and/or processing circuits to execute program code and control basic operations of the device 1400. A “processor” includes any suitable hardware and/or software system, mechanism or component that processes data, signals or other information. A processor may include a system with a general-purpose central processing unit (CPU), multiple processing units, dedicated circuitry for achieving functionality, or other systems. Processing need not be limited to a particular geographic location, or have temporal limitations. For example, a processor may perform its functions in “real-time,” “offline,” in a “batch mode,” etc. Portions of processing may be performed at different times and at different locations, by different (or the same) processing systems. A computer may be any processor in communication with a memory.

Memory 1404 is typically provided in device 1400 for access by the processor 1402, and may be any suitable processor-readable storage medium, e.g., random access memory (RAM), read-only memory (ROM), electrical erasable read-only memory (EEPROM), flash memory, etc., suitable for storing instructions for execution by the processor, and located separate from processor 1402 and/or integrated therewith. Memory 1404 can store software operating on the server device 1400 by the processor 1402, including an operating system 1408, a matchmaking engine 1410 (which may be embodied by the matchmaking engine 140 of FIG. 1), and associated data 1412. In some implementations, animation engine 1410 (and/or other engines) can include instructions that enable processor 1402 to perform or control performance of techniques and functions described herein (e.g., some or all of the implementations of methods 700, 800, and/or 900, or other operations described above).

For example, memory 1404 can include software instructions for matchmaking engine 1410 that can provide customized matchmaking features as described herein (e.g., for a virtual experience platform 100 or other device or system). Any of software in memory 1404 can alternatively be stored on any other suitable storage location or computer-readable medium. Various data used in described features can be stored in memory 1404 and/or other connected storage devices, including player attributes (e.g., attribute component), server attributes, matchmaking rules (e.g., rules component), and other data (e.g., experiences and experience instance data, experience state data, user and player data (with user consent), etc.). Memory 1404 and any other type of storage (magnetic disk, optical disk, magnetic tape, or other tangible media) can be considered “storage” or “storage devices.”

I/O interface 1406 can provide functions to enable interfacing the computing device 1400 with other systems and devices. For example, network communication devices, storage devices (e.g., memory and/or data store 120), and input/output devices can communicate via interface 1406. In some implementations, the I/O interface can connect to interface devices including input devices (keyboard, gamepad or other game controller, pointing device, touchscreen, microphone, camera, scanner, etc.) and/or output devices (display device, speaker devices, printer, motor, etc.).

For ease of illustration, FIG. 14 shows one block for each of processor 1402, memory 1404, I/O interface 1406, software blocks 1408 and 1410, and database 1412. These blocks may represent one or more processors or processing circuitries, operating systems, memories, I/O interfaces, applications, and/or software modules. In other implementations, device 1400 may not have all of the components shown and/or may have other elements including other types of elements instead of, or in addition to, those shown herein. While the virtual experience platform 100 may be described as performing operations as described in some implementations herein, any suitable component or combination of components of virtual experience platform 100 or similar system, or any suitable processor or processors associated with such a system, may perform the operations described.

A user device can also implement and/or be used with features described herein. Example user devices can be computer devices including some similar components as the device 1400 (e.g., processor(s) 1402, memory 1404, and I/O interface 1406). An operating system, software and applications suitable for the client device can be provided in memory and used by the processor. The I/O interface for a client device can be connected to network communication devices, as well as to input and output devices (e.g., a microphone for capturing sound, a camera for capturing images or video, audio speaker devices for outputting sound, a display device for outputting images or video, or other output devices). A display device within the audio/video input/output devices 1414, for example, can be connected to (or included in) the device 1400 to display images pre- and post-processing as described herein, where such display device can include any suitable display device (e.g., an LCD, LED, or plasma display screen, CRT, television, monitor, touchscreen, 3-D display screen, headset, projector, or other visual display device). Some implementations can provide an audio output device, e.g., voice output or synthesis that speaks text.

The methods, techniques, blocks, and/or operations described herein can be performed in a different order than shown or described, and/or performed simultaneously (partially or completely) with other blocks or operations, where appropriate. Some blocks or operations can be performed for one portion of data and later performed again (e.g., for another portion of data). Not all of the described blocks and operations need be performed in various implementations. In some implementations, blocks and operations can be performed multiple times, in a different order, and/or at different times in the methods or techniques.

In some implementations, some or all of the methods and techniques can be implemented on a system such as one or more client devices. In some implementations, one or more methods and techniques described herein can be implemented, for example, on a server system, and/or on both a server system and a client system. In some implementations, different components of one or more servers and/or clients can perform different blocks, operations, or other parts of the methods and techniques.

One or more of the methods and techniques described herein can be implemented by computer program instructions or code, which can be executed on a computer. For example, the code can be implemented by one or more digital processors (e.g., microprocessors or other processing circuitry), and can be stored on a computer program product including a non-transitory computer readable medium (e.g., storage medium), e.g., a magnetic, optical, electromagnetic, or semiconductor storage medium, including semiconductor or solid state memory, magnetic tape, a removable computer diskette, a random access memory (RAM), a read-only memory (ROM), flash memory, a rigid magnetic disk, an optical disk, a solid-state memory drive, etc. The program instructions can also be contained in, and provided as, an electronic signal, for example in the form of software as a service (SaaS) delivered from a server (e.g., a distributed system and/or a cloud computing system). Alternatively, one or more methods can be implemented in hardware (logic gates, etc.), or in a combination of hardware and software. Example hardware can be programmable processors (e.g., field-programmable gate array (FPGA), complex programmable logic device), general purpose processors, graphics processors, application specific integrated circuits (ASICs), and the like. One or more methods can be performed as part of or component of an application running on the system, or as an application or software running in conjunction with other applications and operating systems.

One or more of the methods and techniques described herein can be run in a standalone program that can be run on any type of computing device, a program run on a web browser, a mobile application (“app”) executing on a mobile computing device (e.g., cell phone, smart phone, tablet computer, wearable device (wristwatch, armband, jewelry, headwear, goggles, glasses, etc.), laptop computer, etc.). In one example, a client/server architecture can be used (e.g., a mobile computing device (as a client device) sends user input data to a server device and receives from the server the final output data for output (e.g., for display)). In another example, all computations can be performed within the mobile app (and/or other apps) on the mobile computing device. In another example, computations can be split between the mobile computing device and one or more server devices.

Although the description has been described with respect to particular implementations thereof, these particular implementations are merely illustrative, and not restrictive. Concepts illustrated in the examples may be applied to other examples and implementations.

Note that the functional blocks, operations, features, methods, devices, and systems described in the present disclosure may be integrated or divided into different combinations of systems, devices, and functional blocks. Any suitable programming language and programming techniques may be used to implement the routines of particular implementations. Different programming techniques may be employed (e.g., procedural or object-oriented). The routines may execute on a single processing device or multiple processors. Although the steps, operations, or computations may be presented in a specific order, the order may be changed in different particular implementations. In some implementations, multiple steps or operations shown as sequential in this specification may be performed at the same time.

What is claimed is:

1. A computer-implemented method comprising:
receiving a request from a user device of a requesting user to join a particular virtual experience of a plurality of virtual experiences hosted on a virtual experience platform;
identifying virtual experience instances of the particular virtual experience that are in progress, each of the virtual experience instances executing on a respective server of the virtual experience platform;
determining an initial set of virtual experience instances eligible for the requesting user to join, wherein the initial set of virtual experience instances is a subset of the identified virtual experience instances;
obtaining one or matchmaking scoring criteria that are associated with the particular virtual experience;
determining a respective score for each individual virtual experience instance in the initial set of virtual experience instances based on the one or more matchmaking scoring criteria;
determining, based on the respective scores, a candidate set of virtual experience instances, wherein the candidate set of virtual experience instances is a subset of the initial set of virtual experience instances; and
causing the user device to connect to the server that hosts a particular virtual experience instance of the candidate set of virtual experience instances.

2. The computer-implemented method of claim 1, wherein the particular virtual experience instance of the candidate set of virtual experience instances is associated with a highest score of the respective scores.

3. The computer-implemented method of claim 1, wherein obtaining the one or more matchmaking scoring criteria comprises:
providing a user interface to a developer of the particular virtual experience to provide the one or more matchmaking scoring criteria, the user interface including information indicative of candidate attributes that can be specified in the one or more matchmaking scoring criteria; and
receiving, via the user interface, developer input that specifies the one or more matchmaking scoring criteria, wherein each matchmaking scoring criteria includes at least one of the candidate attributes.

4. The computer-implemented method of claim 3, wherein the matchmaking scoring criteria includes one or more attributes from the candidate attributes, and a respective weight for each of the one or more attributes, and wherein the method further comprises, for each individual virtual experience instance in the initial set:
computing, based on the matchmaking scoring criteria, a respective score associated with each of the one or more attributes; and
computing the score for the individual virtual experience instance as a weighted sum of the respective scores associated with the one or more attributes.

5. The computer-implemented method of claim 4, further comprising obtaining values for the one or more attributes included in the matchmaking scoring criteria for each of the initial set of virtual experiences.

6. The computer-implemented method of claim 5, further comprising computing signal scores for each of the initial set of virtual experiences based on the obtained values for the one or more attributes included in the matchmaking scoring criteria.

7. The computer-implemented method of claim 6, wherein computing the signal scores comprises computing a function of the obtained values for the one or more attributes included in the matchmaking scoring criteria.

8. The computer-implemented method of claim 7, wherein the function is one of an increasing linear function and a decreasing linear function.

9. The computer-implemented method of claim 7, wherein the one or more attributes comprises a number of friends of the requesting user currently participating in the initial set of virtual experience instances, and wherein the function is a non-linear function.

10. The computer-implemented method of claim 1, further comprising determining a join performance of the particular virtual experience, and providing a recommendation to a developer of the particular virtual experience based on the join performance.

11. The computer-implemented method of claim 1, further comprising:
detecting a change in assets associated with the particular virtual experience;
in response to detecting the change, providing an update user interface to a developer of the particular virtual experience to update the matchmaking scoring criteria; and
receiving, via the update user interface, updated matchmaking scoring criteria for the particular virtual experience.

12. The computer-implemented method of claim 1, wherein the matchmaking scoring criteria comprises text input received from a developer of the particular virtual experience, and wherein the computer-implemented method further comprises applying a trained machine learning (ML) model to the received text input to determine one or more weights or signals.

13. A non-transitory computer-readable medium with instructions stored thereon that, responsive to execution by a processing device, cause the processing device to perform or control performance of operations comprising:
receiving a request from a user device of a requesting user to join a particular virtual experience of a plurality of virtual experiences hosted on a virtual experience platform;
identifying virtual experience instances of the particular virtual experience that are in progress, each of the virtual experience instances executing on a respective server of the virtual experience platform;
determining an initial set of virtual experience instances eligible for the requesting user to join, wherein the initial set of virtual experience instances is a subset of the identified virtual experience instances;
obtaining one or matchmaking scoring criteria that are associated with the particular virtual experience;
determining a respective score for each individual virtual experience instance in the initial set of virtual experience instances based on the one or more matchmaking scoring criteria;
determining, based on the respective scores, a candidate set of virtual experience instances, wherein the candidate set of virtual experience instances is a subset of the initial set of virtual experience instances; and
causing the user device to connect to the server that hosts a particular virtual experience instance of the candidate set of virtual experience instances.

14. The non-transitory computer-readable medium of claim 13, wherein the particular virtual experience instance of the candidate set of virtual experience instances is associated with a highest score of the respective scores.

15. The non-transitory computer-readable medium of claim 13, wherein obtaining the one or more matchmaking scoring criteria comprises:
providing a user interface to a developer of the particular virtual experience to provide the one or more matchmaking scoring criteria, the user interface including information indicative of candidate attributes that can be specified in the one or more matchmaking scoring criteria; and
receiving, via the user interface, developer input that specifies the one or more matchmaking scoring criteria, wherein each matchmaking scoring criteria includes at least one of the candidate attributes.

16. The non-transitory computer-readable medium of claim 14, wherein the matchmaking scoring criteria includes one or more attributes from the candidate attributes, and a respective weight for each of the one or more attributes, and wherein the operations further comprise, for each individual virtual experience instance in the initial set:
computing, based on the matchmaking scoring criteria, a respective score associated with each of the one or more attributes; and
computing the score for the individual virtual experience instance as a weighted sum of the respective scores associated with the one or more attributes.

17. A system comprising:
a memory with instructions stored thereon; and
a processing device, coupled to the memory, the processing device configured to access the memory and execute the instructions, wherein the instructions cause the processing device to perform or control performance of operations comprising:
receiving a request from a user device of a requesting user to join a particular virtual experience of a plurality of virtual experiences hosted on a virtual experience platform;
identifying virtual experience instances of the particular virtual experience that are in progress, each of the virtual experience instances executing on a respective server of the virtual experience platform;
determining an initial set of virtual experience instances eligible for the requesting user to join, wherein the initial set of virtual experience instances is a subset of the identified virtual experience instances;
obtaining one or matchmaking scoring criteria that are associated with the particular virtual experience;
determining a respective score for each individual virtual experience instance in the initial set of virtual experience instances based on the one or more matchmaking scoring criteria;
determining, based on the respective scores, a candidate set of virtual experience instances, wherein the candidate set of virtual experience instances is a subset of the initial set of virtual experience instances; and
causing the user device to connect to the server that hosts a particular virtual experience instance of the candidate set of virtual experience instances.

18. The system of claim 17, wherein the operations further comprise determining a join performance of the particular virtual experience, and providing a recommendation to a developer of the particular virtual experience based on the join performance.

19. The system of claim 17, wherein the operations further comprise:
detecting a change in assets associated with the particular virtual experience;
in response to detecting the change, providing an update user interface to a developer of the particular virtual experience to update the matchmaking scoring criteria; and
receiving via the update user interface updated matchmaking scoring criteria for the particular virtual experience.

20. The system of claim 17, wherein the matchmaking scoring criteria comprises text input received from a developer of the particular virtual experience, and wherein the operations further comprise applying a trained machine learning (ML) model to the received text input to determine one or more weights or signals.
